(19) United States
(12) Patent Application Publication
(10) Pub. No.: US 2019/0127009 A1
(43) Pub. Date: May 2, 2019

(54) BRAKING AND CENTERING MECHANISMS FOR FOOT-DECK-BASED VEHICLES

(71) Applicants: Max Basler, Cape Town (ZA); Jaco Kruger, Cape Town (ZA); Anine Kirsten, Cape Town (ZA); Barry Whyte, Curragh (IE)

(72) Inventors: Max Basler, Cape Town (ZA); Jaco Kruger, Cape Town (ZA); Anine Kirsten, Cape Town (ZA); Barry Whyte, Curragh (IE)

(21) Appl. No.: 15/770,036

(22) PCT Filed: Oct. 20, 2016
(86) PCT No.: PCT/EP2016/075291

§ 371 Date: Apr. 20, 2018

Related U.S. Application Data
(60) Provisional application No. 62/244,119, filed on Oct. 20, 2015.

(51) Int. Cl. B62K 3/00; B62K 5/08; B62K 5/10; B62L 1/04; B62L 3/04; B62K 5/05

(52) U.S. Cl. CPC B62K 3/002; B62K 5/08; B62K 5/05; B62L 1/04; B62L 3/04; B62K 5/10

(57) ABSTRACT

Braking and centering mechanisms for foot-deck-based vehicles are described. At least one of the at least one rear wheel of the foot-deck-based vehicle is a braking wheel that is pivotally connected to the foot-deck for swivel movement about a rear swivel axis through a range of angular positions. The braking mechanism comprises a brake member coupled to the rear end of the foot-deck. The brake member is configured to move between a braking position in which the brake member is depressed towards the braking wheel and drives a brake surface to a frictionally engaging position at which the brake surface frictionally engages the braking wheel to reduce a speed of the foot-deck-based vehicle regardless of the angular position of the braking wheel within the range, and a non-braking position in which the brake member permits movement of the brake surface away from the braking wheel.

### FIELD

The specification relates generally to foot-deck-based vehicles, and specifically to braking mechanisms and centering mechanisms for foot-deck-based vehicles.

### BACKGROUND OF THE DISCLOSURE

Foot-deck-based vehicles, such as scooters or skateboards, have become very popular. However, there are a number of drawbacks for typical foot-deck-based vehicles. For example, if the foot-deck-based vehicle includes a wheel that can pivot relative to the foot-deck, and if that wheel is used as a braking wheel, it can be difficult for a user to brake or slow down the foot-deck-based vehicle since the position of the braking wheel can vary while the foot-deck-based vehicle is in use.

For foot-deck-vehicles that are steered by leaning, the amount of leaning load required to steer the foot-deck-based vehicle is typically set during manufacturing and cannot be adjusted. A heavier person will likely apply the leaning load more easily than a lighter person (e.g., in the case of an adult using the foot-deck-based vehicle as opposed to a child). If the set leaning load is based on the lighter person's weight, then the foot-deck-based vehicle may be too unstable for the heavier person to use. If the set leaning load is based on the heavier person's weight, then the lighter person will likely have more difficulty steering the foot-deck-based vehicle. As a result, for many typical foot-deck-based vehicles, the same foot-deck-based vehicle cannot be used for multiple persons having multiple weights.

It may be helpful to develop mechanisms that may address these problems.

### SUMMARY OF THE DISCLOSURE

According to a set of embodiments, there is provided a mechanism for a foot-deck-based vehicle. The foot-deck-based vehicle includes a foot-deck with a front end and a rear end, and a plurality of wheels positioned in association with the foot-deck. The plurality of wheels includes at least one front wheel proximate the front end and at least one rear wheel proximate the rear end. At least one of the at least one rear wheel is a braking wheel that is pivotally connected to the foot-deck for swivel movement about a rear swivel axis through a range of angular positions. The braking mechanism includes a brake member coupled to the rear end of the foot-deck. The brake member is configured to move between a braking position in which the brake member is depressed towards the braking wheel and drives a brake surface to a frictionally engaging position at which the brake surface frictionally engages the braking wheel to reduce a speed of the foot-deck-based vehicle regardless of the angular position of the braking wheel within the range, and a non-braking position in which the brake member permits movement of the brake surface away from the braking wheel.

According to another set of embodiments, there is provided a foot-deck-based vehicle that includes a foot-deck with a front end and a rear end, a plurality of wheels and a braking mechanism. The plurality of wheels is positioned in association with the foot-deck and includes at least one front wheel proximate the front end and at least one rear end. At least one of the at least one rear wheel is a braking wheel that is pivotally connected to the foot-deck for swivel movement about a swivel axis through a range of angular positions. The braking mechanism includes a brake member coupled to the rear end of the foot-deck. The brake member is configured to move between a braking position in which the brake member is depressed towards the braking wheel and drives a brake surface to a frictionally engaging position at which the brake surface frictionally engages the braking wheel to reduce a speed of the foot-deck-based vehicle regardless of the angular position of the braking wheel within the range, and a non-braking position in which the brake member permits movement of the brake surface away from the braking wheel.

According to another set of embodiments, there is provided a centering mechanism for a front wheel assembly of a foot-deck-based vehicle. The front wheel assembly has a front wheel support configured to pivot about a front wheel support pivot axis at an acute angle to a vertical axis when the foot-deck-based vehicle is upright, and a first front wheel and a second front wheel. The centering mechanism includes a resilient member and an adjustable bearing member. The resilient member is coupled to the front wheel support and to the foot-deck. The adjustable bearing member is configured to be moveable between a first position in which the adjustable bearing member applies a first compressive force to the resilient member thereby providing the resilient member with a first effective spring rate for resisting pivoting of the front wheel support about the front wheel support pivot axis, and a second position in which the adjustable bearing member applies a second compressive force to the resilient member thereby providing the resilient member with a second effective spring rate for resisting pivoting of the front wheel support about the front wheel support pivot axis, whereby the second effective spring rate is higher than the first effective spring rate.

According to another set of embodiments, there is provided a braking mechanism for a foot-deck-based vehicle having a foot-deck with a front end and a rear end, and a plurality of wheels positioned in association with the foot-deck. The plurality of wheels includes at least one front wheel proximate the front end and at least one rear wheel proximate the rear end. At least one of the at least one rear wheel is a braking wheel. The braking wheel is pivotally connected to the foot-deck for swivel movement about a swivel axis via a rear wheel support coupled to the foot-deck. The braking mechanism includes at least one brake member coupled to the rear end of the foot-deck and movable to brake the braking wheel and a locking member coupled to the at least one brake member. The locking member is configured to move between a non-locking position out of engagement with the rear wheel support, and a locking position in which the locking member engages the rear wheel support to restrict swivel movement of the braking wheel.

According to another set of embodiments, there is provided a foot-deck-based vehicle, comprising a foot deck defining a foot support plane, a front wheel support configured to support the foot deck and to pivot about a front wheel support pivot axis having an acute angle to the foot support plane, a first front wheel and a second front wheel rotatably mounted to the front wheel support, and a centering mechanism. The centering mechanism includes a resilient member coupled to the front wheel support and to the foot-deck, and a cam lever movable between a first position in which the cam lever causes a first compressive force to be applied to the resilient member causing the resilient member to have a first effective spring rate in relation to resisting pivoting of the front wheel support about the front wheel support pivot axis, and a second position in which the cam lever causes a second compressive force to be applied to the resilient member causing the resilient member to have a second effective spring rate in relation to resisting pivoting of the front wheel support about the front wheel support pivot axis, wherein the second effective spring rate is greater than the first effective spring rate.

### BRIEF DESCRIPTIONS OF THE DRAWINGS

For a better understanding of the various embodiments described herein and to show more clearly how they may be carried into effect, reference will now be made, by way of example only, to the accompanying drawings in which:

FIG. 1 is a front perspective view of a foot-deck-based vehicle, according to a non-limiting embodiment;

FIG. 2A is a front perspective view of the foot-deck-based vehicle depicted in FIG. 1 with a rear braking wheel pivoted out of alignment with the foot-deck of the foot-deck-based vehicle, according to a non-limiting embodiment;

FIG. 2B is a top plan view of the foot-deck-based vehicle depicted in FIG. 2A;

FIG. 3 is a side elevation view of the foot-deck-based vehicle depicted in FIG. 1;

FIG. 4 is a front elevation view of the foot-deck-based vehicle depicted in FIG. 1;

FIG. 5 is a cross-section view of a braking mechanism in which a primary brake member is in a non-braking position, according to a non-limiting embodiment;

FIG. 6 is a cross-section view of the braking mechanism depicted in FIG. 5 in which the primary brake member is in a braking position, according to a non-limiting embodiment;

FIG. 7 is a schematic of a section of the foot-deck-based vehicle 100 taken along cross-section lines E-E depicted in FIG. 3;

FIG. 8A is a top plan view of a secondary brake member that is pivoted out of alignment with a primary brake member when the primary brake member is in a non-braking position, according to a non-limiting embodiment;

FIG. 8B is a side elevation view of the secondary brake member and the primary brake member depicted in FIG. 8A;

FIG. 8C is a top plan view of the braking mechanism and the braking wheel depicted in FIG. 8A that is connected to the foot-deck for swivel movement about a rear swivel through a range of angular positions;

FIG. 9A is a top plan view of a secondary brake member that is pivoted out of alignment with a primary brake member when the primary brake member is in a braking position, according to a non-limiting embodiment;

FIG. 9B is a side elevation view of the secondary brake member and the primary brake member depicted in FIG. 9A;

FIG. 10A is a cross-section view of a braking mechanism having a locking mechanism in the unlocking position, according to a non-limiting embodiment;

FIG. 10B is a cross-section view of the braking mechanism and the locking mechanism depicted in FIG. 10B, with the locking mechanism in a locking position, according to a non-limiting embodiment;

FIG. 10C is a cross-section view of the braking mechanism and the locking mechanism depicted in FIG. 10B, with the locking mechanism in a locking position and the primary brake member in a braking position, according to a non-limiting embodiment;

FIG. 10D is a partially exploded view of the braking mechanism depicted in FIG. 10A;

FIG. 10E is a cross-section view of the braking mechanism and the locking mechanism depicted in FIG. 10A;

FIG. 10F is a second partially exploded view of the braking mechanism depicted in FIG. 10A;

FIG. 11A is a partially exploded view of a foot-deck-based vehicle having a front wheel assembly and a centering mechanism for the front wheel assembly with a resistance adjustment mechanism, according to a non-limiting embodiment;

FIG. 11B is an enlarged view of the front wheel assembly and the centering mechanism depicted in FIG. 11B;

FIG. 12 is a cross-section view of the front wheel assembly and the centering mechanism depicted in FIGS. 11A and 11B;

FIG. 13A is a cross-section view of the front wheel assembly and the centering mechanism depicted in FIGS. 11A to 12, when an adjustable bearing member applies a first compressive force to a resilient member, according to a non-limiting embodiment;

FIG. 13B is a cross-section view of the front wheel assembly and the centering mechanism depicted in FIGS. 11A to 12, when an adjustable bearing member applies a second compressive force to a resilient member, according to a non-limiting embodiment;

FIG. 14 is an enlarged top plan view of a front wheel assembly for a foot-deck-based vehicle, according to a non-limiting embodiment;

FIG. 15 is an enlarged top plan view of a front wheel support and a centering mechanism when the front wheel support pivots in a first direction, according to a non-limiting embodiment;

FIG. 16A is a perspective view of a resilient member, according to a non-limiting embodiment;

FIG. 16B is a side elevation view of the resilient member depicted in FIG. 16A;

FIG. 17 is an enlarged top plan view of a front wheel support and a centering mechanism with a resistance adjustment mechanism, when the resilient member generates a first resistive force that resists pivoting of the front wheel, according to a non-limiting embodiment;

FIG. 18 is an enlarged top plan view of the front wheel support and the centering mechanism shown in FIG. 17, when the resilient member generates a second resistive force that resists pivoting of the front wheel;

FIG. 19A is a top plan view of a secondary brake member having a boss to on an exterior braking surface, according to a non-limiting embodiment;

FIG. 19B is a bottom plan view of a primary brake member having an engagement bracket, according to a non-limiting embodiment;

FIG. 20 is a side elevation view of a braking mechanism for a foot-deck-based vehicle in which the braking mechanism includes a single brake, according to a non-limiting embodiment;

FIG. 21 is a front perspective view the braking mechanism depicted in FIG. 20;

FIG. 22 is a rear perspective view of the braking mechanism depicted in FIG. 20;

FIG. 23 is a top perspective view of the braking mechanism depicted in FIG. 20;

FIG. 24 is a perspective view of a foot-deck-based vehicle, according to a non-limiting embodiment;

FIG. 25 is a side elevation view of the foot-deck-based vehicle depicted in FIG. 24;

FIG. 26 is perspective view of the foot-deck-based vehicle depicted in FIG. 24;

FIG. 27A is a top plan view of a braking mechanism and a braking wheel, according to a non-limiting embodiment;

FIG. 27B is a side elevation view of the braking mechanism depicted in FIG. 27A;

FIG. 27C is a top plan view of the braking mechanism and the braking wheel depicted in FIG. 27A that is connected to the foot-deck for swivel movement about a rear swivel through a range of angular positions;

FIG. 28A is a rear perspective view of the braking mechanism depicted in FIG. 27A;

FIG. 28B is a perspective view of the braking mechanism depicted in FIG. 27A;

FIG. 28C is a perspective view the braking mechanism depicted in FIG. 27A;

FIG. 29A is a cross-section view of the braking mechanism depicted in FIG. 27A;

FIG. 29B is a cross-section view of the braking mechanism depicted in FIG. 27A with the brake member in a braking position;

FIG. 29C is a cross-section view of the braking mechanism depicted in FIG. 27A just prior to the brake member being in the braking position;

FIG. 29D is a top plan view of the braking mechanism depicted in FIG. 27A in which the brake member and the braking wheel are aligned;

FIG. 30 is a cross-section view of a braking mechanism having a locking mechanism in the unlocked position, according to a non-limiting embodiment;

FIG. 31 is a cross-section view of the braking mechanism having the locking mechanism depicted in FIG. 30, with the locking mechanism in the locked position, according to a non-limiting embodiment; and

FIG. 32 is a cross-section view of the braking mechanism having the locking mechanism depicted in FIG. 30, with the locking mechanism in the locked position and the brake member in the braking position, according to a non-limiting embodiment;

FIG. 33A is a perspective view of a front wheel support with an alternative resistance adjustment mechanism employing a cam lever, wherein the cam lever is shown in a release position;

FIG. 33B is a perspective view of the front wheel support shown in FIG. 33A in a first position;

FIG. 33C is a perspective view of the front wheel support shown in FIG. 33A in a second position;

FIG. 34 is a sectional elevation view of the front wheel support shown in FIG. 33A; and

FIG. 35 is an exploded perspective view of elements of the front wheel support shown in FIG. 33A.

### DETAILED DESCRIPTION

Described herein are mechanisms to assist with braking and steering of foot-deck-based vehicles. In some embodiments, the foot-deck-based vehicles include a wheel that is connected to the foot-deck such that the wheel swivels or pivots about a swivel axis, similarly to a wheel in a swivel castor wheel assembly. The swivelling wheel may make it easier to steer the foot-deck-based vehicles, particularly if the foot-deck-based vehicles are steered by leaning the foot-deck while the foot-deck-based vehicle is in motion.

In various related embodiments, the described braking mechanisms may provide a consistent location for a user to apply a braking initiation force that is transferred to the swivelling wheel over multiple positions of the swivelling wheel about the swivel axis. In some embodiments, the braking mechanisms include a locking member that can be used to restrict swivel movement of the swivelling wheel when it is desirable.

Some embodiments include centering mechanisms for adjusting the amount of leaning load required to steer the foot-deck-based vehicles. As a result, a stable ride may be achieved using the same foot-deck-based vehicle for users of different weights, such as a child and an adult. If a child is riding the foot-deck-based vehicle, the stiffness may be set at a level to require less of a leaning load to steer the vehicle than if a heavier adult were to use the foot-deck-based vehicle. Alternatively, if a user prefers a relatively less stable ride than another user, the stiffness may be adjusted to lower the leaning load required to steer the foot-deck-based vehicle to a level that would provide the desired amount of “tippy-ness”.

It is understood that for the purpose of this disclosure, language of “at least one of X, Y, and Z” and “one or more of X, Y and Z” can be construed as X only, Y only, Z only, or any combination of two or more items X, Y, and Z (e.g., XYZ, XYY, YZ, ZZ).

It is also understood that the terms “couple”, “coupled”, “connect”, “connected” are not limited to direct mating between the described components, but also contemplate the use of intermediate components to achieve the connection or coupling.

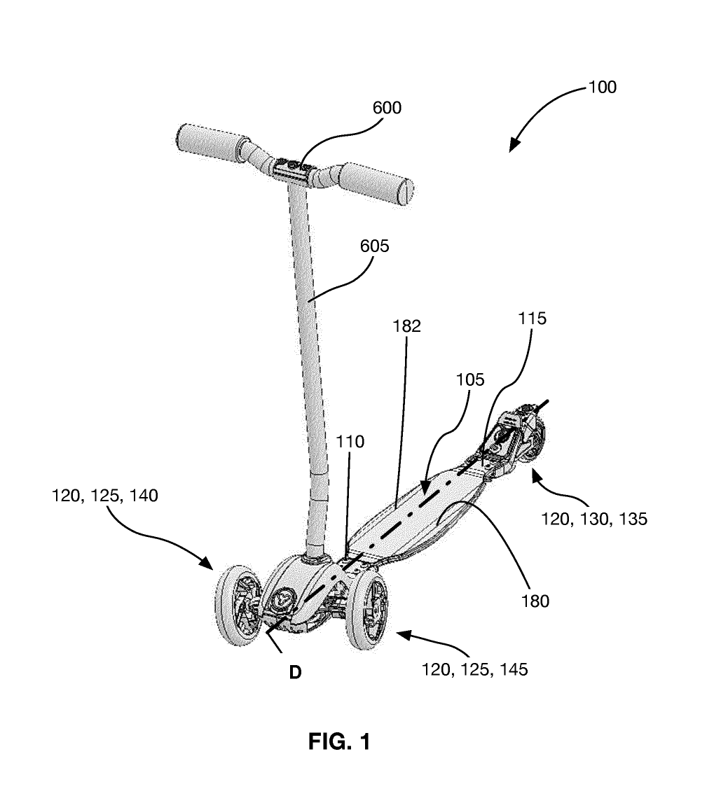

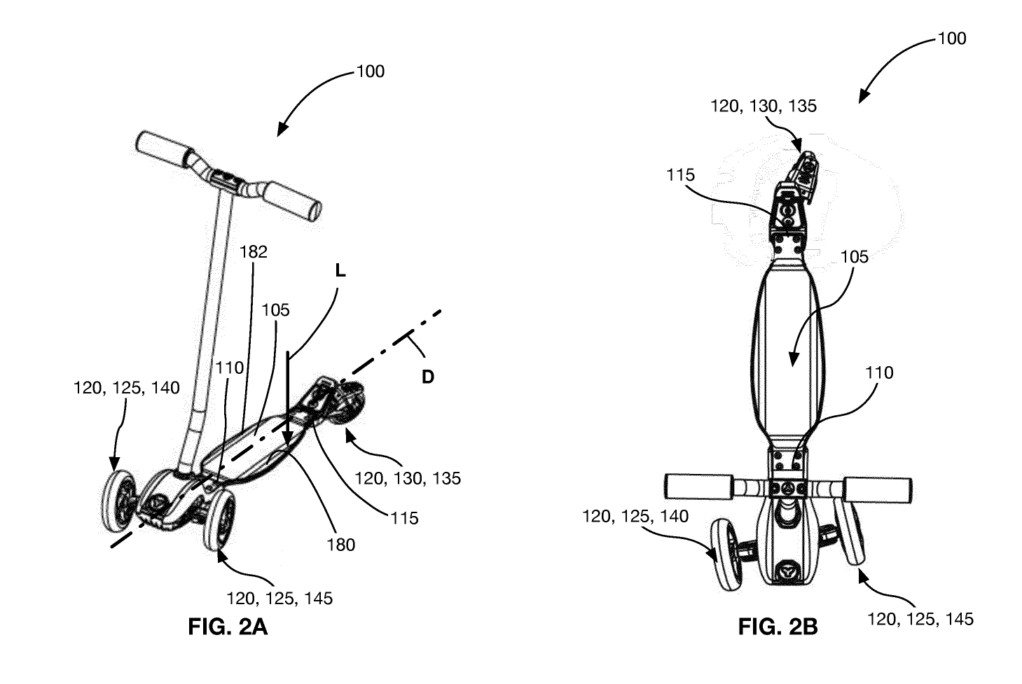

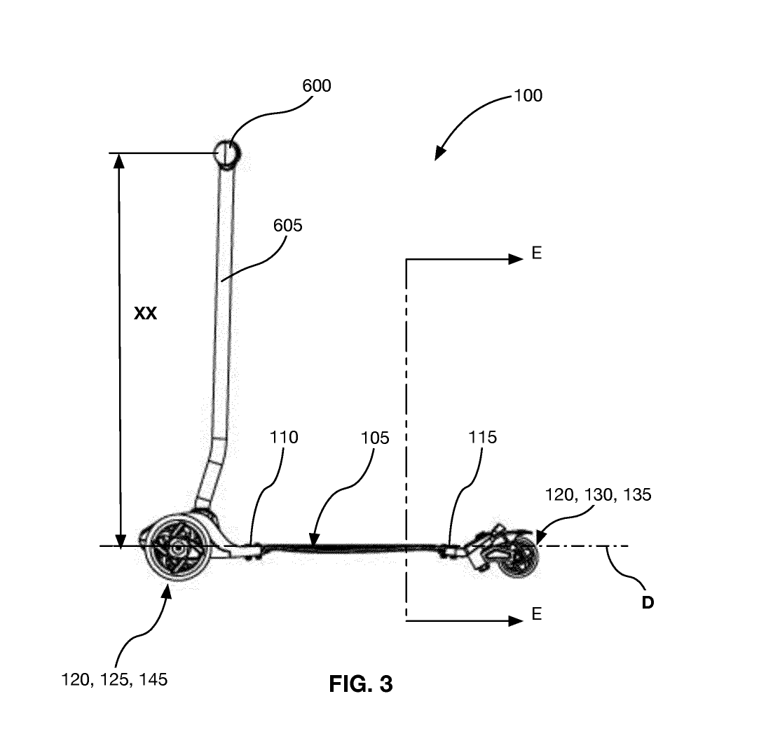

FIGS. 1 to 4 depict an example foot-deck-based vehicle 100, which may be, for example, a scooter as shown in FIGS. 1 to 4. Although the example foot-deck-based vehicle 100 is depicted as a scooter, it is understood that the foot-deck-based vehicle 100 is not limited to a scooter and may be, for example, a skateboard, or any other suitable foot-deck-based vehicle. The foot-deck-based vehicle 100 includes a foot-deck 105 having a front end 110 and a rear end 115 and a plurality of wheels 120. The plurality of wheels includes at least one front wheel 125 proximate the front end 110 and at least one rear wheel 130 proximate the rear end 115. In the example foot-deck-based vehicle 100, the at least one front wheel includes a first front wheel 140 and a second front wheel 145. However, in some embodiments, the foot-deck-based vehicle 100 may have only one front wheel and, in some other embodiments, the foot-deck-based vehicle 100 may have more than two front wheels.

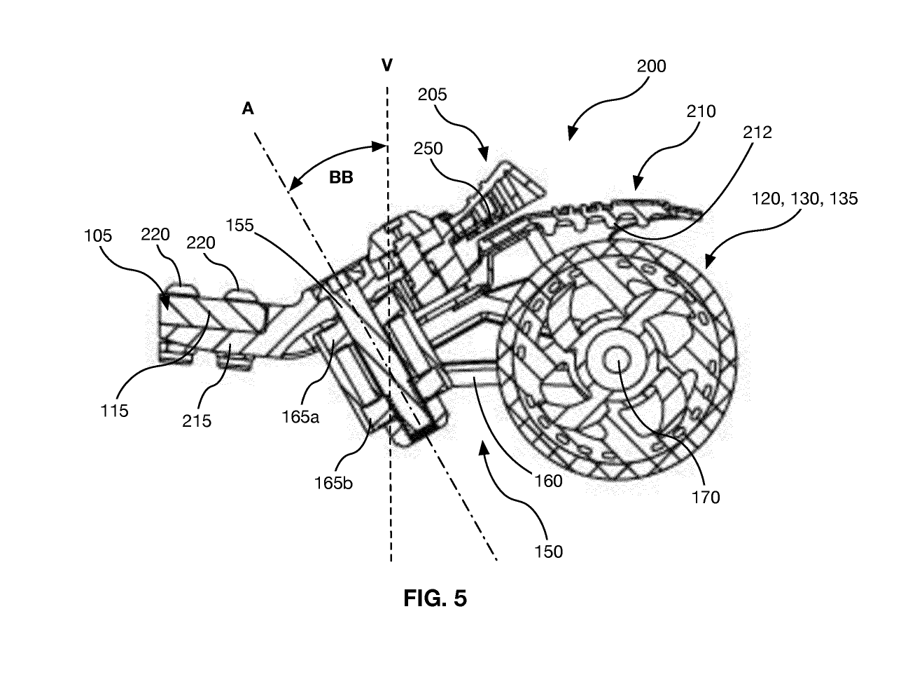

At least one of the at least one rear wheel 130 is a braking wheel 135. The braking wheel 135 is pivotally connected to the foot-deck 105 for swivel movement about a rear swivel axis through a range of angular positions (about the rear swivel axis). For example, as shown in FIG. 5, the braking wheel 135 is included in a braking wheel assembly 150 that includes a rear pin 155 and a rear wheel support 160. The rear pin 155 has a rear pin longitudinal axis A that defines the swivel axis of the braking wheel 135 and is at an acute angle BB (i.e., an angle greater than zero degrees and less than 90 degrees) relative to a vertical axis V when the foot-deck-based vehicle 100 is upright, and is therefore at an acute angle (which is the complimentary angle to angle BB) generally relative to a foot support plane on the foot deck 105. The foot support plane is the upper surface of the foot deck 105 (i.e. the surface of the foot deck that the rider's feet rest on). The rear wheel support 160 is pivotally coupled to the rear pin 155 via, for example, bushings 165a and 165b. However, any suitable manner of pivotally coupling the rear wheel support 160 to the rear pin 155 is contemplated. For example, in some embodiments, the bushings 165a and 165b are substituted by ball bearings or roller bearings. Furthermore, any suitable manner of pivotally connecting the braking wheel 135 to the foot-deck 105 is contemplated.

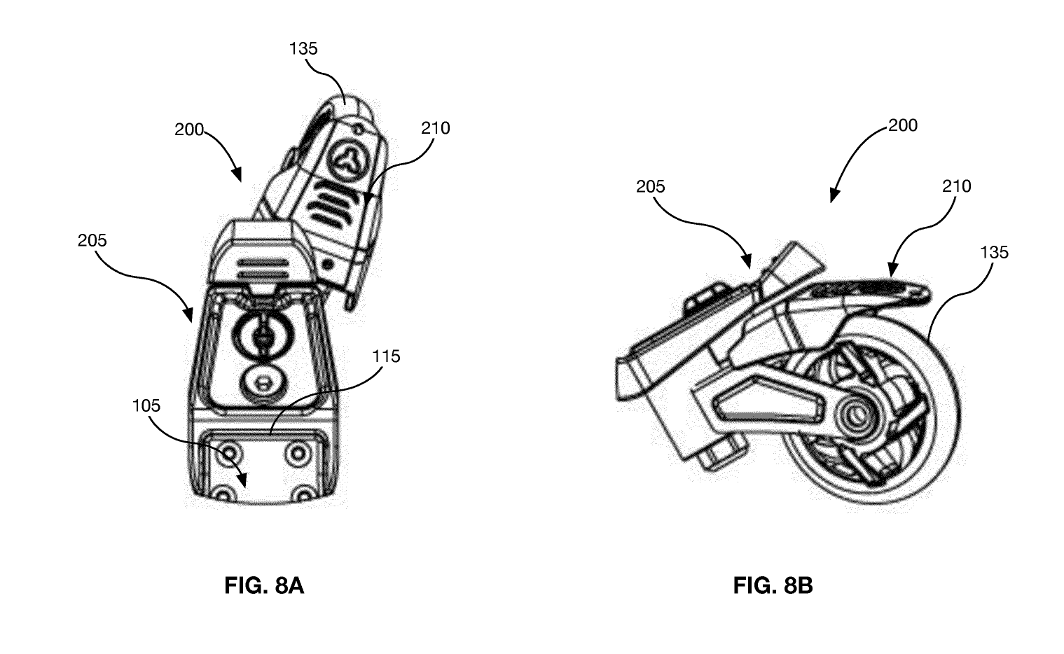

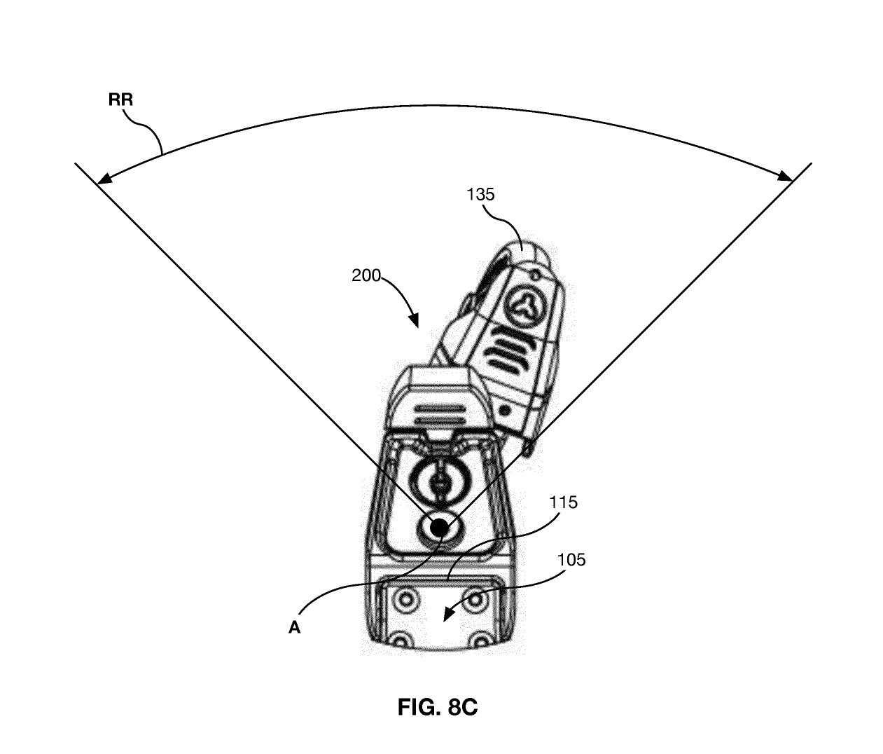

The braking wheel 135 is rotatably coupled on the rear wheel support 160. For example, the braking wheel 135 is rotatably coupled to the rear wheel support 160 by rear axle 170. The rear wheel support 160 is pivotally coupled to the rear pin 155. The rear wheel support 160 and the braking wheel 135 are then able to pivot together about the rear pin longitudinal axis A. Again, the braking wheel 135 is connected for swivel movement about the rear swivel axis (the rear pin longitudinal axis A for the example braking wheel 135), through a range of angular positions R, as shown in FIG. 8C.

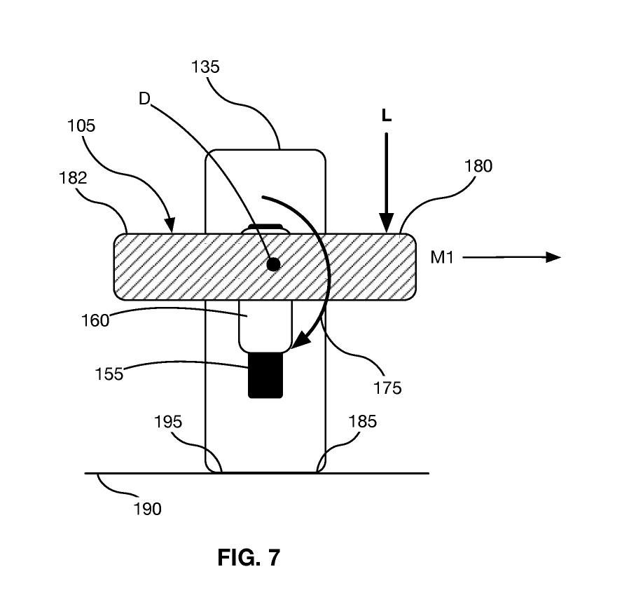

Including a swivelling wheel, such as the braking wheel 135, may be helpful in steering the foot-deck-based vehicle 100. As shown in FIG. 7, a laterally offset load L (i.e., a load L that is offset laterally from a generally central longitudinal axis D of the foot-deck 105) may be applied to one side or the other of the foot-deck 105 (i.e., wherein the foot-deck has first and second sides 180 and 182, surrounding the longitudinal axis D of the foot-deck 105). When the laterally offset load L is applied to the first side 180, the rear pin 155, the braking wheel 135 and the rear wheel support 160 pivot about the longitudinal axis D of the foot-deck 105 with the foot-deck 105. As a result, a corresponding side 185 of the braking wheel 135 is pressed into the surface 190 more than the opposite side 195 of the braking wheel 135 and the foot-deck-based vehicle 100 is steered in the general direction M1. Furthermore, when the laterally offset load L is applied to the second side 182, the foot-deck-based vehicle 100 is steered in the opposite direction.

As better shown by FIGS. 8A and 8B, the braking wheel 135 is configured to pivot about the swivel axis relative to the foot-deck 105 and a primary brake member 205 that is further described below.

Referring to FIGS. 5, 6 and 8A to 9B, the example foot-deck-based vehicle 100 includes an example braking mechanism 200. The braking mechanism 200 includes the primary brake member 205 and a secondary brake member 210 that work together to reduce a speed of the foot-deck-based vehicle 100. In some embodiments, the secondary brake member 210 is rear wheel support 160. In some embodiments, the braking mechanism 200 includes a single brake member. In some other embodiments, the braking mechanism 200 includes more than two brake members.

The primary brake member 205 is coupled to the rear end 115 of the foot-deck 105. In some embodiments, the primary brake member 205 is coupled to the rear end 115 of the foot-deck 105 in a cantilevered manner. For example, the primary brake member 205 can include a first end 215 that is coupled to the rear end 115 using fasteners 220, and a free end 225 that is free to engage the secondary brake member 210. The braking mechanism 200 is operated by pressing the primary brake member 205 towards and into engagement with the secondary brake member 210, as further described below. The primary brake member 205 does not pivot with the braking wheel 135 and provides a consistent location for a user of the foot-deck-based vehicle 100 to actuate the braking mechanism 200, even if the braking wheel 135 has swivelled or pivoted out of alignment with the foot-deck 105 (e.g., out of alignment with the longitudinal axis D of the foot-deck 105).

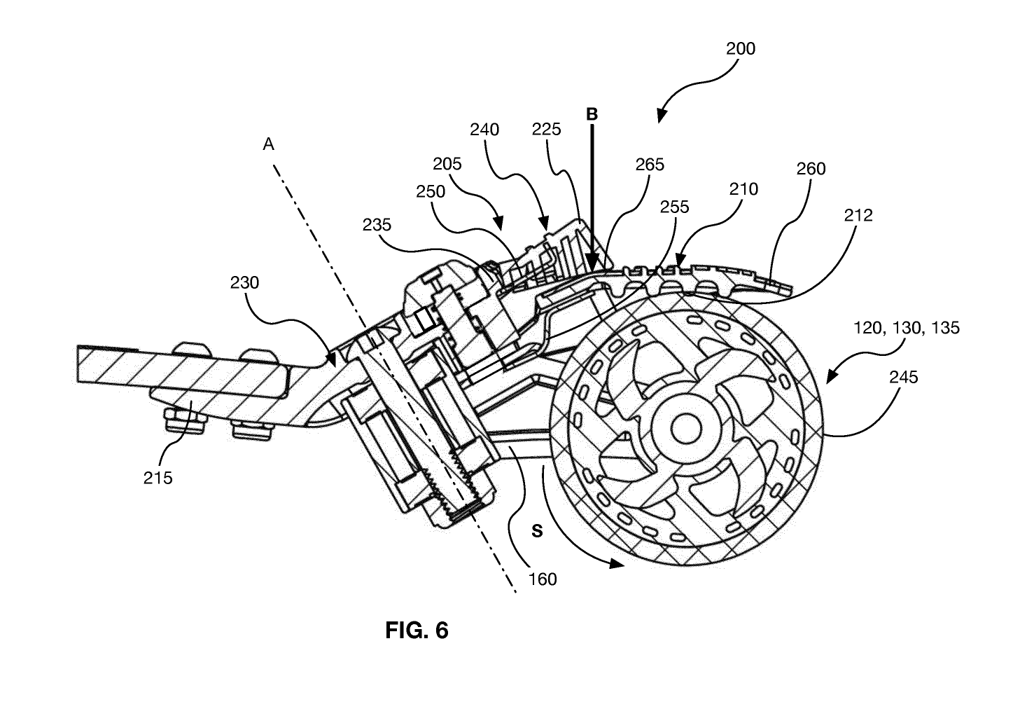

The primary brake member 205 is configured to move between a braking position (FIG. 6) in which the primary brake member 205 is depressed towards the braking wheel 135 and drives a brake surface to a frictionally engaging position at which the brake surface frictionally engages the braking wheel 135 to reduce a speed of the foot-deck-based vehicle 100 regardless of the angular position of the braking wheel 135 within the range of angular positions RR.

For example, the primary brake member 205 can be configured to move between a braking position in which the primary brake member 205 is depressed towards the secondary brake member 210 and applies a transfer force B to the secondary brake member 210 (FIG. 6) and a non-braking position away from the secondary brake 210 (FIG. 5). In some embodiments, the primary brake member 205 includes an extension portion 230, which includes the first end 215, and an engagement portion 240, which is coupled to a second end 235 of the extension portion 230, and includes the free end 225. The engagement portion 240 is configured to apply the transfer force B to the secondary brake member 210 (at, for example, an exterior braking surface 265 of the secondary brake member 210) when the primary brake member 205 is in the braking position. The engagement portion 240 may be formed from any suitable material or combination of suitable materials, such as a suitable rubber or plastic.

The primary brake member 205 can be biased to the non-braking position. For example, the primary brake member 205 can be made from a resilient material that returns to the non-braking position when the user is no longer pressing on the primary brake member 205. As another example, the primary brake member 205 may include a spring, such as a leaf spring 250 (FIGS. 5 and 6), that is biased to urge the primary brake member 205 to the non-braking position. In some embodiments, the extension portion 230 is stationary and the engagement portion 240 moves relative to the second end 235 between the non-braking and the braking positions.

In use, the primary brake member 205 is moved to a braking position and applies the transfer force B to the secondary brake member 210. While the transfer force B is applied to the secondary brake member 210 by the primary brake member 205, the secondary brake member 210 moves towards the braking wheel 135. In the example braking mechanism, the brake surface is on the secondary brake member 210, particularly brake surface 212, and the application of the transfer force B by the primary brake member 205 drives the brake surface 212 to a frictionally engaging position at which the brake surface 212 frictionally engages the braking wheel 135 to reduce a speed of the foot-deck-based vehicle 100 regardless of the angular position of the braking wheel 135 within the range of angular positions RR.

For example, as the braking wheel 135 rotates in the direction S, the brake surface 212 on the secondary brake member 210 is dragged against an exterior surface 245 of the braking wheel 135 (FIG. 6), countering the rotation of the braking wheel 135 in the direction S. In some embodiments, the secondary brake member 210 is omitted and the brake surface is on the primary brake member 205.

In the non-braking position (FIG. 5), the primary brake member 205 permits movement of the brake surface 212 away from the braking wheel 135. For example, as stated above, the primary brake member 205 can be biased to the non-braking position. As a result, when the primary brake member is not being depressed towards the braking wheel 135 (and the secondary brake member 210), the primary brake member 205 can move to the non-braking position. In some embodiments, the primary brake member 205 coupled to the rear end 115 of the foot-deck 105 in a cantilevered manner and is resiliently movable between the braking and non-braking positions by way of a living hinge.

As shown in FIGS. 8A and 8B, the secondary brake member 210 is connected for pivoting movement with the braking wheel 135 about the rear swivel axis, which in the example braking mechanism 200 is the rear pin longitudinal axis A. For example, the secondary brake member 210 can be coupled to the rear wheel support 160. As shown in FIG. 6, the secondary brake member 210 can include a proximal end 255 that is coupled to the rear wheel support 160 and a free end 260 that is distal to the proximate end 255.

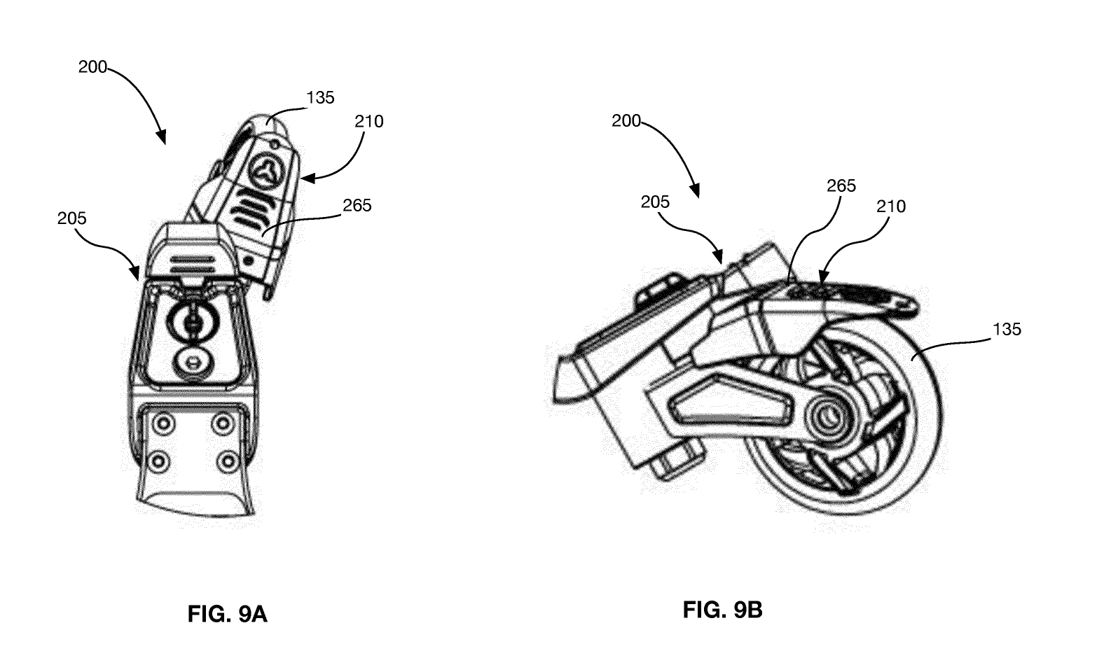

The secondary brake member 210 is positioned to receive the transfer force B and to frictionally engage the braking wheel 135 when the primary brake member 205 is in the braking position. As shown in FIGS. 9A and 9B, the primary brake member 205 and the secondary brake member 210 are located in respect of each other such that the primary brake member 205 is able to contact the exterior braking surface 265 of the secondary brake member 210, even when the primary brake member 205 and the secondary brake member 210 are not aligned with each other. In some embodiments, the exterior braking surface 265 is sized to provide the primary brake member 205 with a location on the exterior braking surface 265 to apply the transfer force B over a number of pivot locations of the secondary brake member 210. In some embodiments, the primary brake member 205 is sized such that the secondary brake member 210 can receive the transfer force B over a number of pivot locations of the secondary brake member 210.

As stated above, the braking wheel 135 of the braking mechanism 200 may be free to swivel or pivot about the swivel axis A as the primary brake member 205 moves between the non-braking and braking positions. In some situations, the user may want a more traditional ride of the foot-deck-based vehicle 100 and to restrain the braking wheel 135 from swivelling movement.

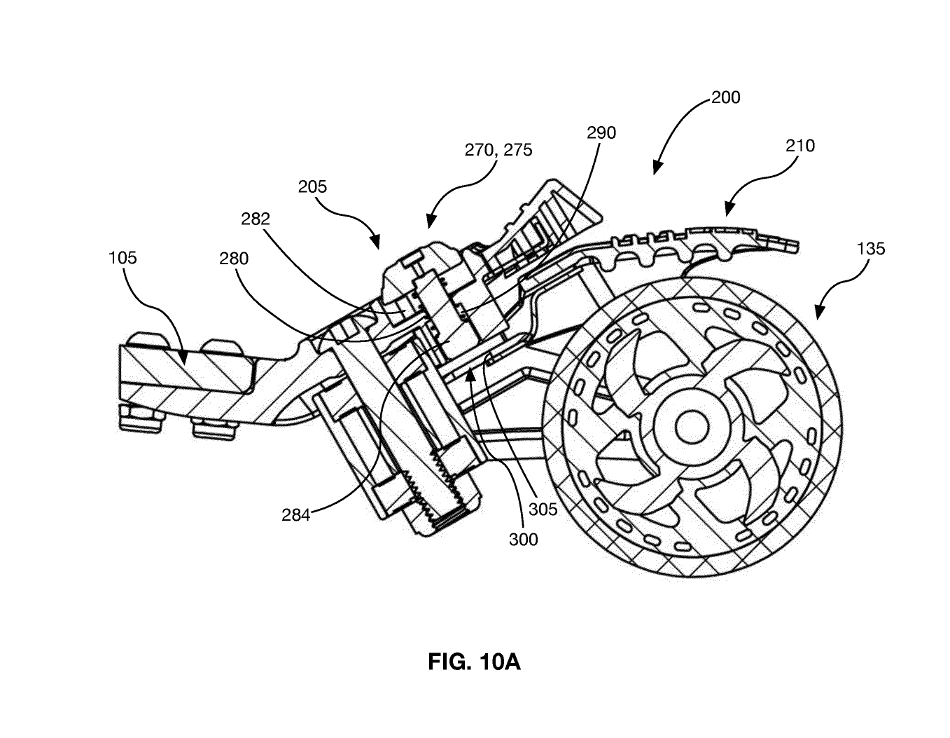

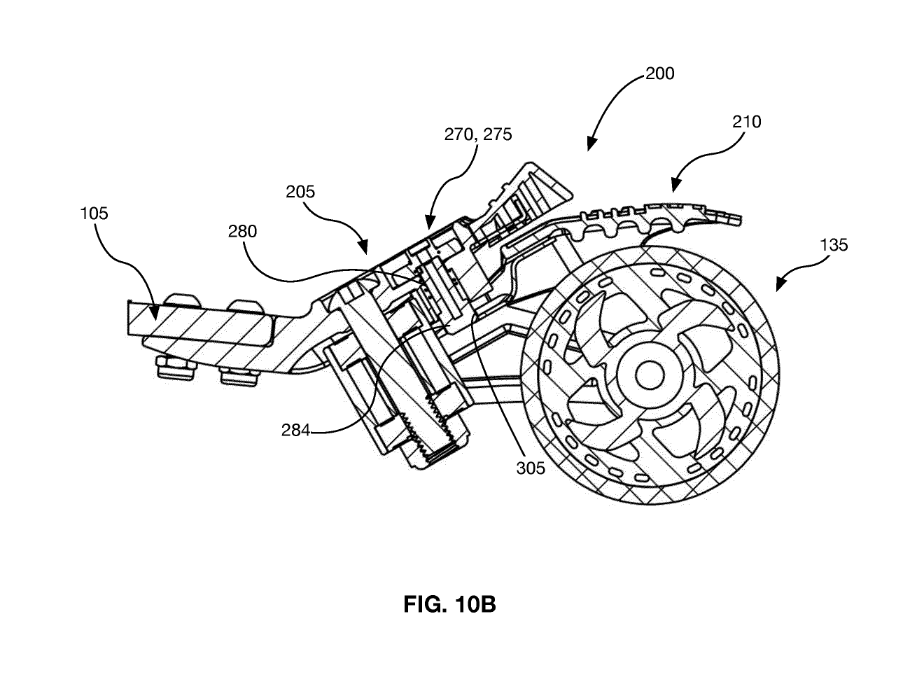

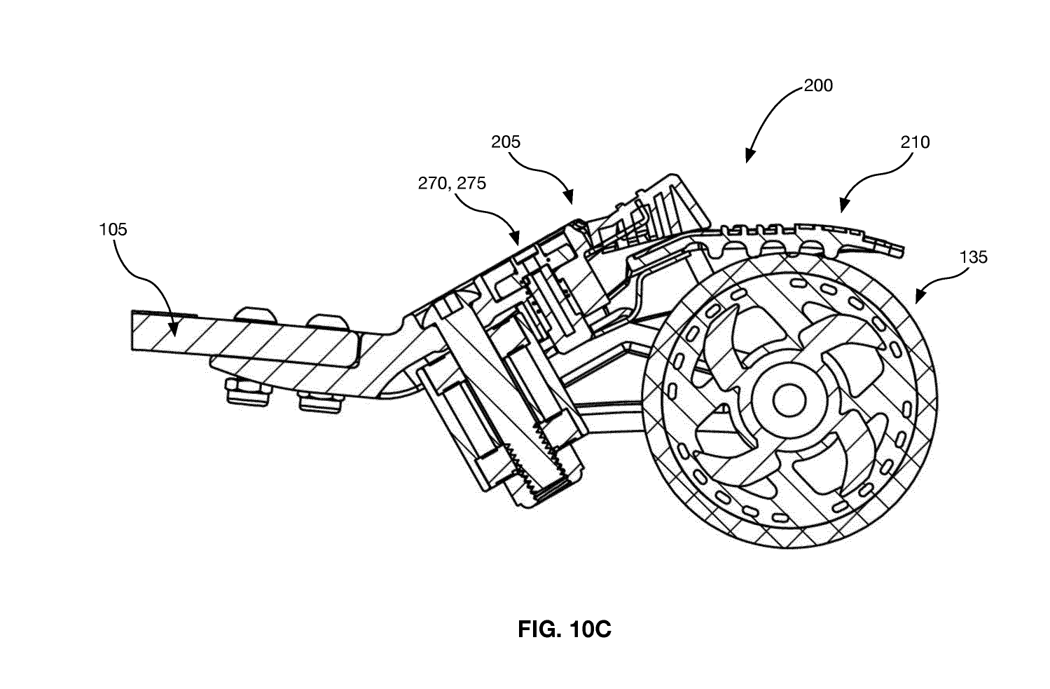

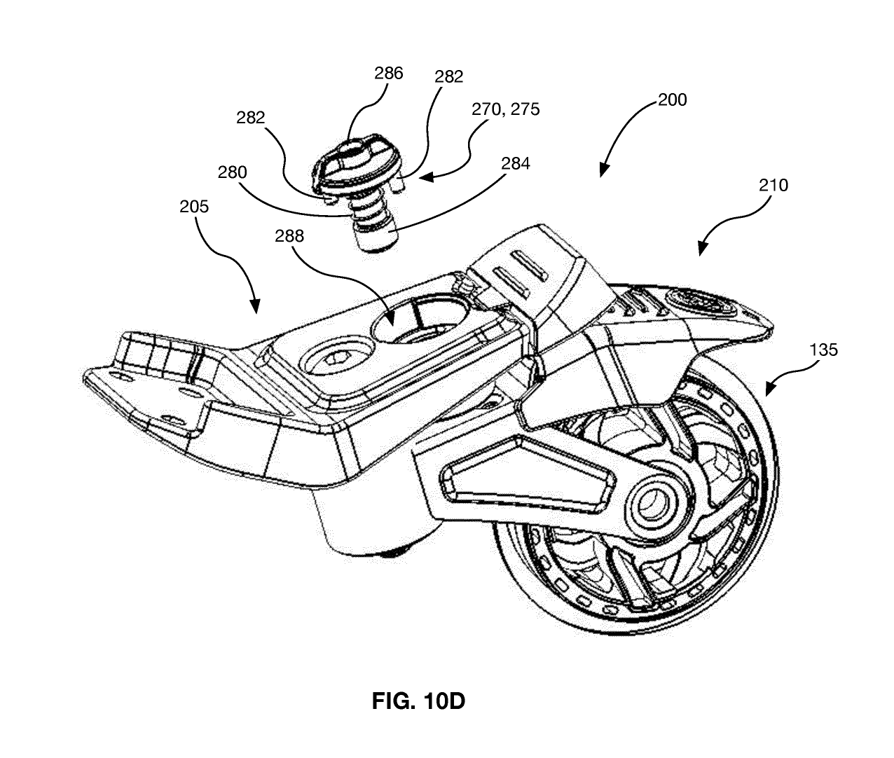

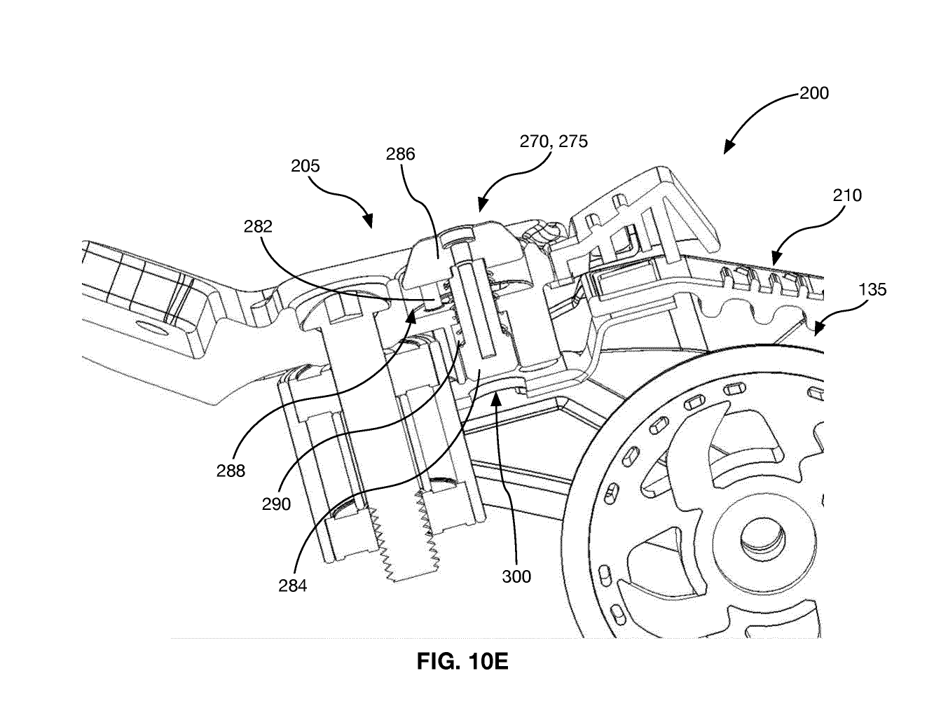

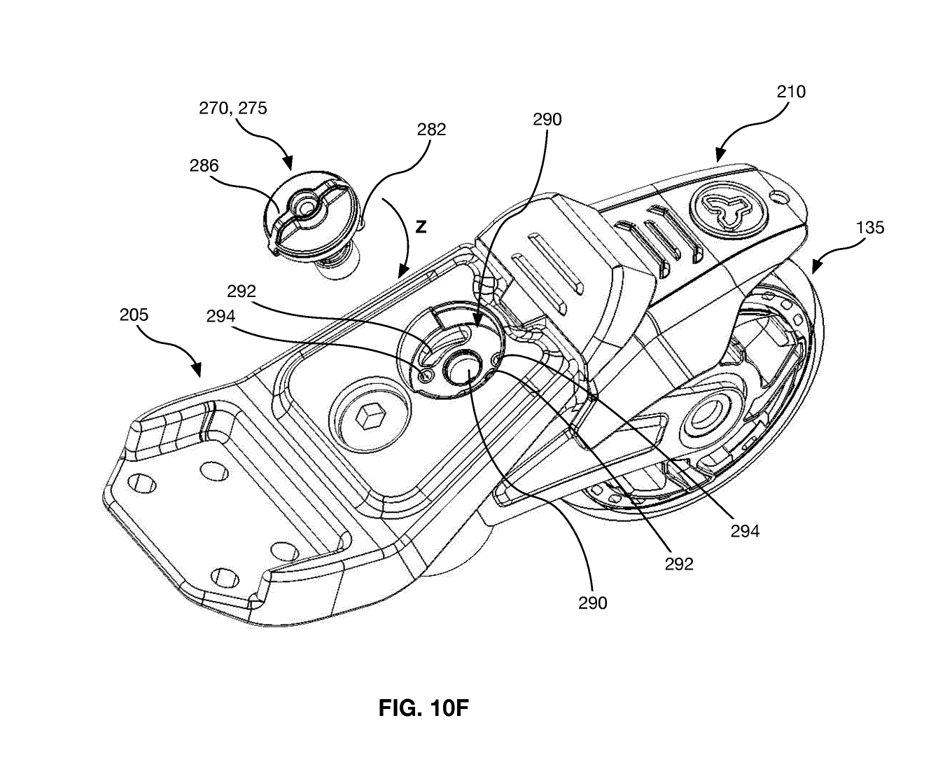

Referring to FIGS. 10A to 10F, the braking mechanism 200 includes an example locking member 270 that is coupled to at least one brake member. In this example, the locking member 270 is coupled to the primary brake member 205. The locking member 270 is configured to move between a non-locking position out of engagement with the rear wheel support 160 (FIG. 10A) and a locking position in which the locking member 270 engages the rear wheel support 160 to restrict swivel movement of the braking wheel 135 (FIG. 10B). For example, the locking member 270 can be a spring-loaded pin 275 that is biased to the locking position. The locking member 270 includes a spring 280, traveling arms 282, an engagement member 284 and a graspable member 286 (FIG. 10D). In use, the spring-loaded pin 275 is seated in a recess 288 (FIG. 10D) and a locking member aperture 290 of the primary brake member 205. As shown in FIG. 10F, the recess 288 includes a declining ramp 292 and, for each one of the traveling arms 282, a retaining cavity 294 sized for a respective one of the traveling arms 282.

The rear wheel support 160 can include a lock engagement aperture 300 that is configured to fittingly receive the locking member 270 when the locking member 270 is in the locking position. For example, the lock engagement aperture 300 can be sized and shaped to correspond with the size and shape of the engagement member 295 of the locking member 270. As shown in FIG. 10B, while in the locking position, the engagement member 295 frictionally engages an interior surface 305 of the lock engagement aperture 300 to help retain the locking member 270 in the lock engagement aperture 300. The braking wheel 135 is then restricted to moving with the foot-deck 105 and the primary brake member 205, and prevented from swivel movement about the swivel axis.

In the non-locking position (FIGS. 10A and 10E), the traveling arms 282 rest in their respective retaining cavity 294 and the engagement member 295 is suspended above the lock engagement aperture 300. In order to move the locking member 270 from the non-locking position to the locking position, the locking member 270 is manipulated (e.g., by using the graspable member 286) such that the traveling arms 282 are disengaged from the retaining cavities 294 and placed in the declining ramps 292. While the locking member 270 is seated in the recess 288 with the traveling arms 282 in their respective declining ramps 292, the locking member 270 is pivoted in the direction Z (FIG. 10F) such that the locking member 270 travels towards the lock engagement aperture 300 in the wheel support 160 and until the engagement member 295 is fittingly received in the lock engagement aperture 300.

To release the locking member 270 from the lock engagement aperture 300, the locking member 270 can be pulled from the lock engagement aperture 300 using, for example, the graspable member 286 and re-positioned such that the traveling arms 282 are resting in the retaining cavities 294.

The braking mechanism 200 can still be used to reduce the speed of the foot-deck-based vehicle 100 even when the braking wheel 135 is locked by the locking member 270. As shown in FIGS. 10B and 10C, the primary brake member 205 remains moveable between the non-braking (FIG. 10B) and braking positions (FIG. 10C) while the locking member 270 is in the locked position. Although the locking member 270 is shown with braking mechanism 200 having two brake members (the primary brake member 205 and the secondary brake member 210), the locking member 270 may be used with only one brake that is coupled to the foot-deck 105 and is moveable between a non-braking position in which the brake member permits movement of the brake surface away from the braking wheel 135 and a braking position in which the single brake drives the brake surface to a frictionally engaging position at which the brake surface frictionally engages the braking wheel 135 to reduce the speed of the foot-deck-based vehicle 100. Alternatively, in some embodiments, the locking member 270 is included with a braking mechanism having more than two brake members.

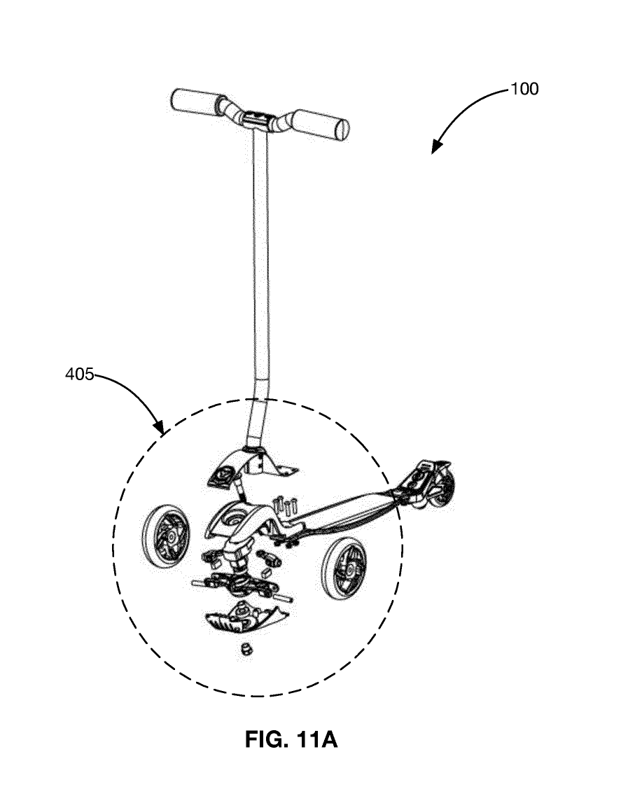

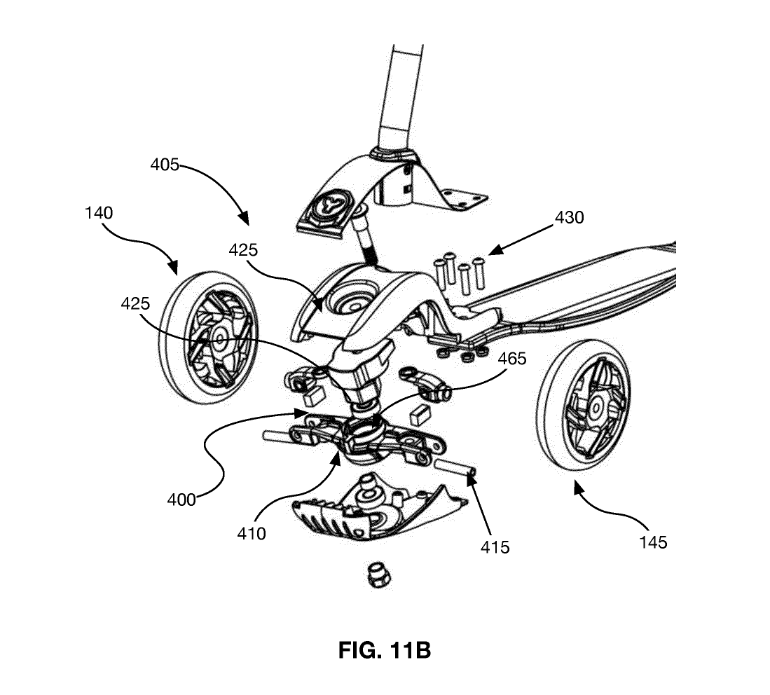

As stated above, it may be desirable to be able to adjust of the amount of leaning load required to steer the foot-deck-based vehicles. FIGS. 11A to 14 show an example centering mechanism 400 of the foot-deck-based vehicle 100. The foot-deck-based vehicle 100 is shown with the centering mechanism 400 as an example of the type of foot-deck-based vehicle that the centering mechanism 400 can be used with. For example, in some embodiments the centering mechanism 400 is used with a foot-deck-based vehicle that does not include a swivelling wheel.

The example centering mechanism 400 is provided for a front wheel assembly 405 of the foot-deck-based vehicle 100. The front wheel assembly 405 includes the first front wheel 140 and the second front wheel 145, and a front wheel support 410. The front wheel support 410 rotatably supports the first front wheel 140 and the second front wheel 145 via, for example, axles 415 (also referred to individually as axle 415).

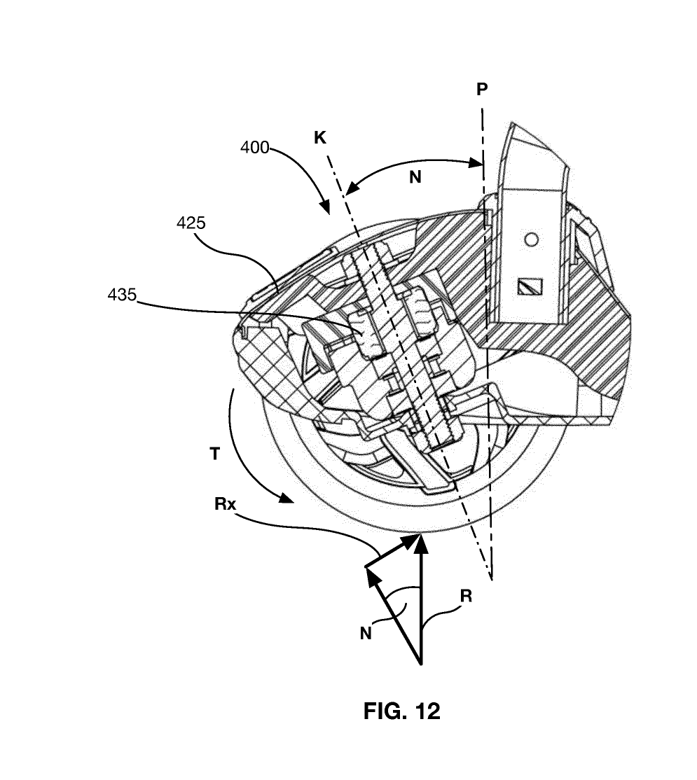

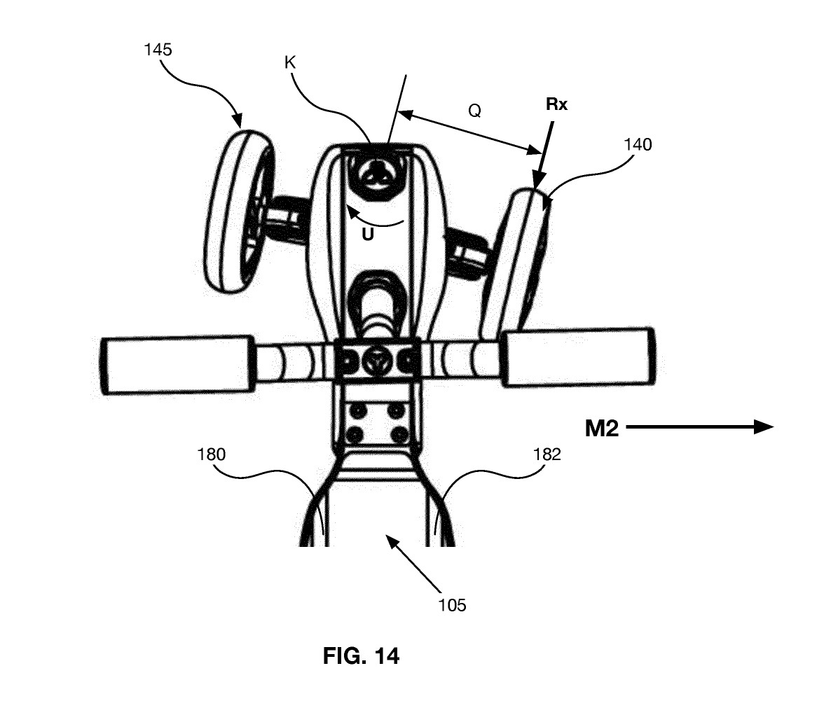

The front wheel support 410 is also configured to pivot about a front wheel support pivot axis K that is at an acute angle N to a vertical axis P when the foot-deck-based vehicle 100 is upright (FIG. 12). The acute angle N is in the direction away from the rear end 115 of the foot-deck 105. Placing the front wheel support pivot axis K at an acute angle to the vertical axis P aids in steering the foot-deck-based vehicle 100. When a user applies a leaning load (not shown) to another side 182 of the foot-deck 105 (FIG. 14), the leaning load is transmitted through the foot-deck 105, a front cover 425 connected to the front end 110 (by, for example, fasteners 430) and the centering mechanism 400 to the front wheel support 410. The leaning load is then transmitted to the first front wheel 140 via the axle 415. The first front wheel 140 will be subjected to a reaction force R (FIG. 12) that opposes the leaning load. Due to the angle N, the component of the reaction force R, Rx, causes the first front wheel 140 to rotate in the direction T. As shown in FIG. 14, the component reaction force Rx acts on the first front wheel 140 at a perpendicular distance Q from the front wheel support pivot axis K, which generates a moment U about the front wheel support pivot axis K to turn the front wheel support 410 and to steer the foot-deck-based vehicle 100 in the general direction M2. Furthermore, as shown in FIG. 14, the front wheel support 410 pivots relative to the foot-deck 105.

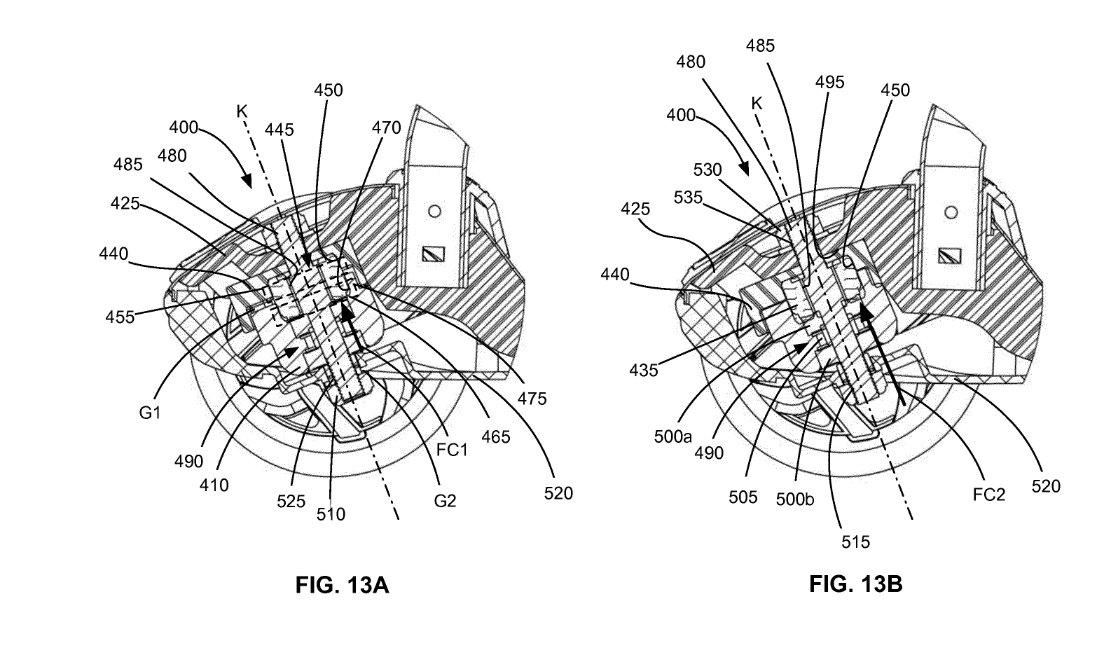

The centering mechanism 400 includes a resilient member 435 that is coupled to the front wheel support 410 and to the foot-deck 105. As shown in FIGS. 13A and 13B, the resilient member 435 is coupled to the foot-deck 105 via a positioning member 440, which is coupled to the front cover 425. The positioning member 440 is coupled to the front cover 425 and the foot-deck 105 such that pivotal movement relative to the foot-deck 105 is restricted. The positioning member 440 includes a recess 445 having sides 450. At least a portion 455 of the resilient member 435 is retained in the recess 445. The resilient member 435 abuts the sides 450 of the positioning member 440 such that relative movement between the portion 455 of the resilient member 435 and the positioning member 440 is restricted.

The resilient member 435 is also coupled to the front wheel support 410. The front wheel support 410 includes a recess 465 having sides 470. At least another portion 475 of the resilient member 435 is retained in the recess 465. The resilient member 435 abuts the sides 470 of the second positioning member 460 such that relative movement between the portion 475 of the resilient member 435 and the front wheel support 410 is restricted.

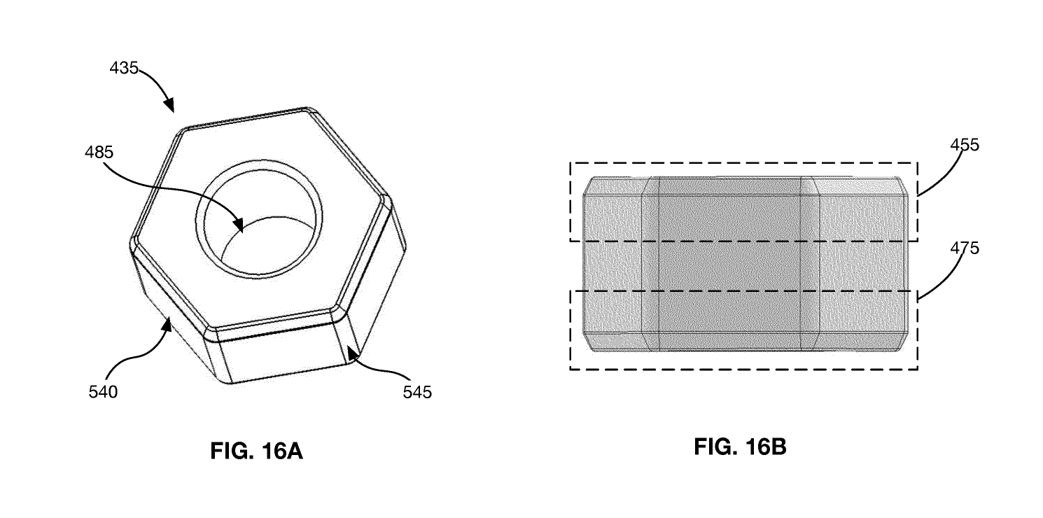

In the example centering mechanism 400, the foot-deck 105 (via the front cover 425), the positioning member 440, the resilient member 435 and the front wheel support 410 are connected via a front pin 480 that is aligned with the front wheel support pivot axis K. The resilient member 435 includes a resilient member aperture 485 (FIG. 16A) and is at least partially sleeved on the front pin 480 via the resilient member aperture 485 in that the front pin 480. However, any suitable connection or connections between the resilient member 435, the foot-deck 105 and the front wheel support 410 such that relative pivotal movement between the portion 455 and the foot-deck 105, and relative pivotal movement between the portion 475 and the front wheel support 410 are restricted is contemplated.

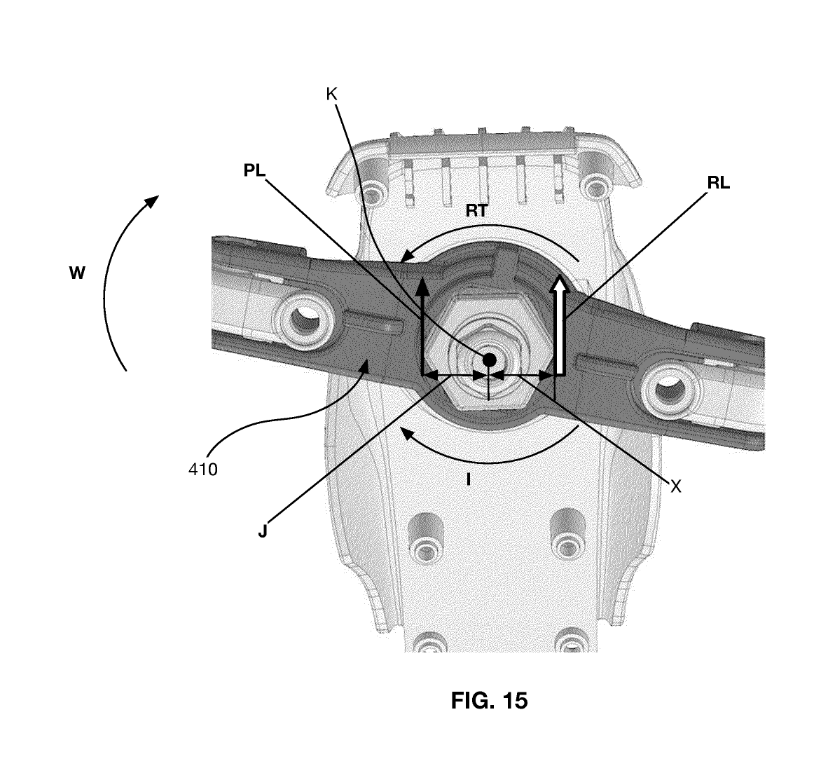

In the example centering mechanism 400, the resilient member 435 is generally aligned with the front wheel support pivot axis K. However, any suitable positioning of the resilient member 435 is contemplated. Since the resilient member 435 is coupled to both the front wheel support 410 and the foot-deck 105, the resilient member 435 resists relative pivotal movement between the front wheel support 410 and the foot-deck 105. For example, when the front wheel support 410 is pivoted about the front wheel support pivot axis K in the direction W (FIG. 15), the front wheel support 410 (via sides 475) applies a pivot load PL against the portion 475 of the resilient member 435 that is retained in the recess 465 of the front wheel support 410. The pivot load PL is applied to the portion 475 at a distance J from the front wheel support pivot axis K and generates a pivot torque I about the front wheel support pivot axis K, which twists the portion 475 with the pivot load. Since the portion 455 of the resilient member 435 is retained in the recess 445 of the positioning member 440, and the positioning member 440 (along with the front cover 425 and the foot-deck 105) does not pivot with the front wheel support 410, the portion 455 generates a resistive force RL at a distance X (the distance from the front wheel support pivot axis K to the to sides 450) to produce a resisting torque RT to resist pivoting of the front wheel support 410 about the front wheel support pivot axis K. In some embodiments, the distance X and the distance J are different. In some other embodiments, the distance X and the distance J are the same. As a resilient component, the amount of resistive force RL that is generated by the resilient member 435 is based on the stiffness of the material from which the resilient member 435 is made (in other words, the spring constant) and the amount of deformation or strain the resilient member 435 is under when the pivot load PL is being applied.

The centering mechanism 400 optionally includes a resistance adjustment mechanism that allows the amount of the resistive force RL to be adjusted for a given non-zero amount of pivoting movement of the front wheel support 410 away from a neutral position (the neutral position being the position in which the front wheel support extends directly laterally). Therefore, in the example shown in FIGS. 13A and 13B, the resistance adjustment mechanism allows the effective spring rate of the resilient member 435 to be adjusted. The resistance adjustment mechanism includes an adjustable bearing member 490 that is configured to be moveable between a first position in which the adjustable bearing member 490 applies a first compressive force FC1 to the resilient member 435 (FIG. 13A), and a second position in which the adjustable bearing member 490 applies a second compressive force FC2 to the resilient member 435 (FIG. 13B) , m. that is greater than the first compressive force FC1. The adjustable bearing member 490 is coupled to the front pin 480 and travels along the front pin 480 between the first position and the second position.

In some embodiments, the adjustable bearing member 490 includes at least one bushing, such as bushings 500a, 500b (FIG. 13B). The adjustable bearing member 490 may further include a spacer 505 between the bushings 500a and 500b.

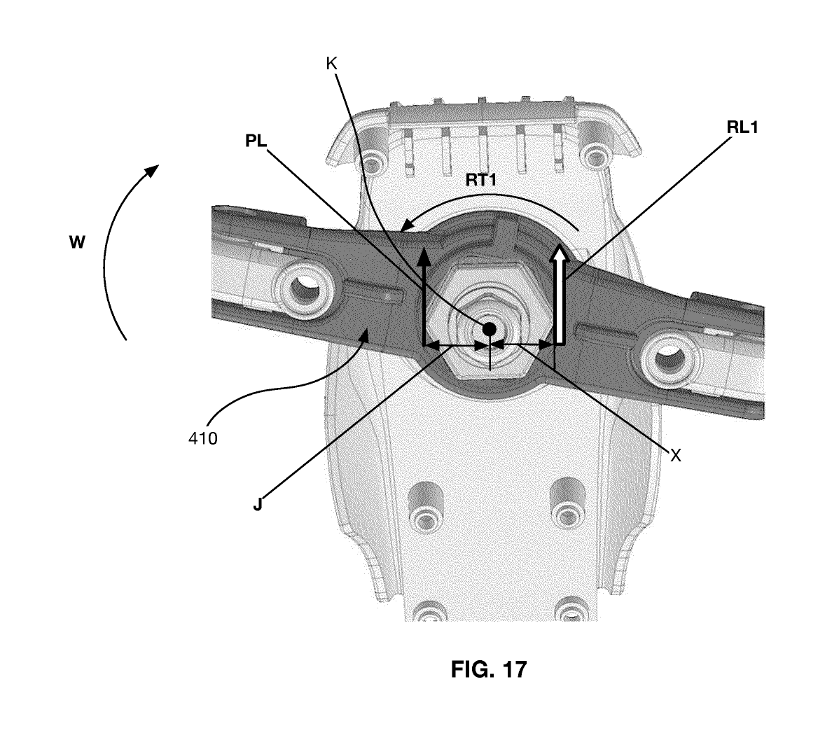

In the first position, the adjustable bearing member 490 can abut the resilient member 435 and press against the resilient member 435 to apply the first compressive force FC1. Under the first compressive force FC1, the resilient member 435 sustains a first amount of deformation and generates a first resistive force RL1, and a first resisting torque RT1, that resists pivoting of the front wheel support 410 about the front wheel support pivot axis K for a given non-zero pivot angle of the front wheel support 410 away from a neutral position (FIG. 17), thereby providing the resilient member 435 with a first effective spring rate. It is understood that the first compressive force FC1 can be approximately zero.

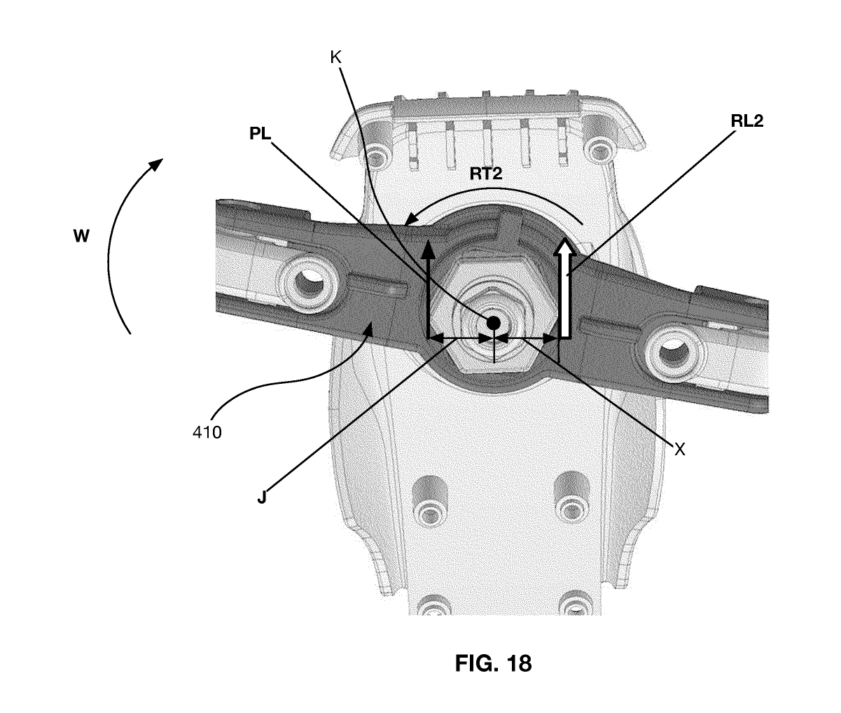

In the second position, the adjustable bearing member 490 abuts the resilient member 435 and presses against the resilient member 435 to apply a second compressive force FC2 that is, as noted above, greater than the first compressive force FC1. Movement of the resilient member 435 is limited by the sides 450 and a first limiting surface 495 of the recess 445 in the positioning member 440 (FIG. 13B). Under the second compressive force FC2, the resilient member 435 sustains a second amount of deformation that is greater than the first amount of deformation and generates a second resistive force RL2, and a second resisting torque RT2, that resists pivoting of the front wheel support 410 about the front wheel support pivot axis K for the same given non-zero pivot angle of the front wheel support 410 away from a neutral position (FIG. 18), thereby providing the resilient member 435 with a second effective spring rate. Since the second resistive force RL2 is greater than the first resistive force RL1, the leaning load required to reach the given non-zero pivot angle when the resilient member 435 is compressed with the second compressive force FC2 will be greater than the leaning load required to reach the given non-zero pivot angle when the resilient member 435 is compressed with the second compressive force FC1. Therefore, the second effective spring rate is higher than the first effective spring rate.

In some embodiments, the centering mechanism 400 includes a resistance adjustment mechanism, which includes a driver 510 that is coupled to the front pin 480 and is configured to move the adjustable bearing member 490 between the first position and the second position (FIGS. 13A, 13B). For example, the front pin 480 can include threads 515 and the driver 510 can be a nut that is configured to engage the threads 515 to travel along the front pin 480. In the example resistance adjustment mechanism, the driver 510 is coupled to the front pin 480 beneath a bottom cover 520 that is also coupled to the foot-deck 105 (not shown). As the driver 510 travels along the front pin 480 towards the resilient member 435, the driver 510 presses against the bottom cover 520 (and washer 525 that can abut the adjustable bearing member 490), which presses against the adjustable bearing member 490, to move the adjustable bearing member 490 along the front pin 480 to press against the resilient member 435. In the particular example shown, the front wheel support 410 moves with the adjustable bearing member 435. The distance the adjustable member 490 can travel along the front pin 480 can be limited by, for example, the size of a first gap G1 between the front wheel support 410 and the positioning member 440. However, the distance the adjustable bearing member 490 can be moved may be limited in other ways. For example, the size of a second gap G2 between the driver 510 and the bottom cover 520 may also be used to limit the distance the adjustable bearing member 490 can be moved. In some embodiments, the first gap G1 is between 2 to 4 mm. In some embodiments, the second gap G2 is between 2 and 4 mm. In some embodiments, only the second gap G2 is present.

The example resistance adjustment mechanism also includes a fastener 530 that prevents the front cover 425, the positioning member 440 and the resilient member 435 from traveling along the front pin 480 in response to the first compressive force FC1 or the second compressive force FC2. Although, the fastener 530 is depicted as a nut that engages another set of threads 535 on the front pin 480, any suitable fastener is contemplated.

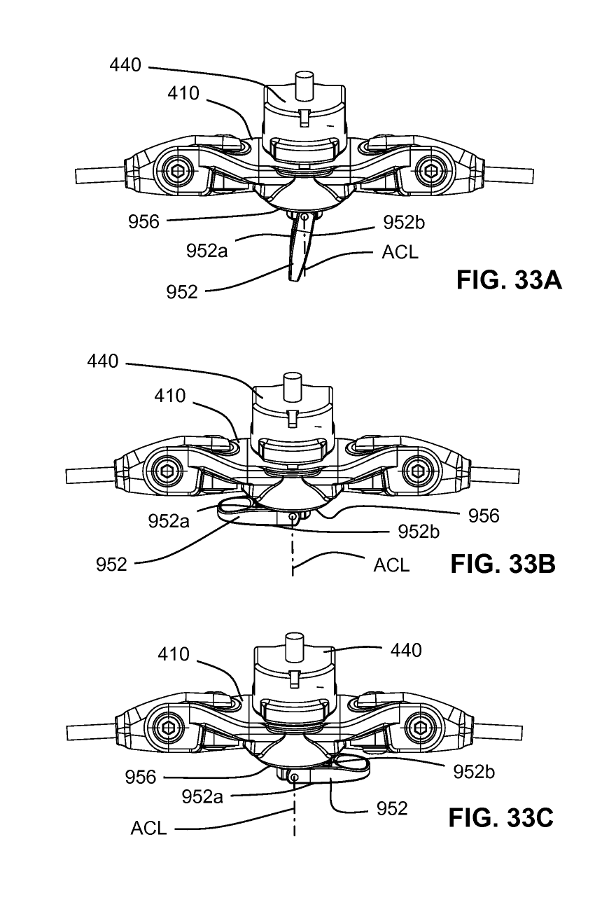

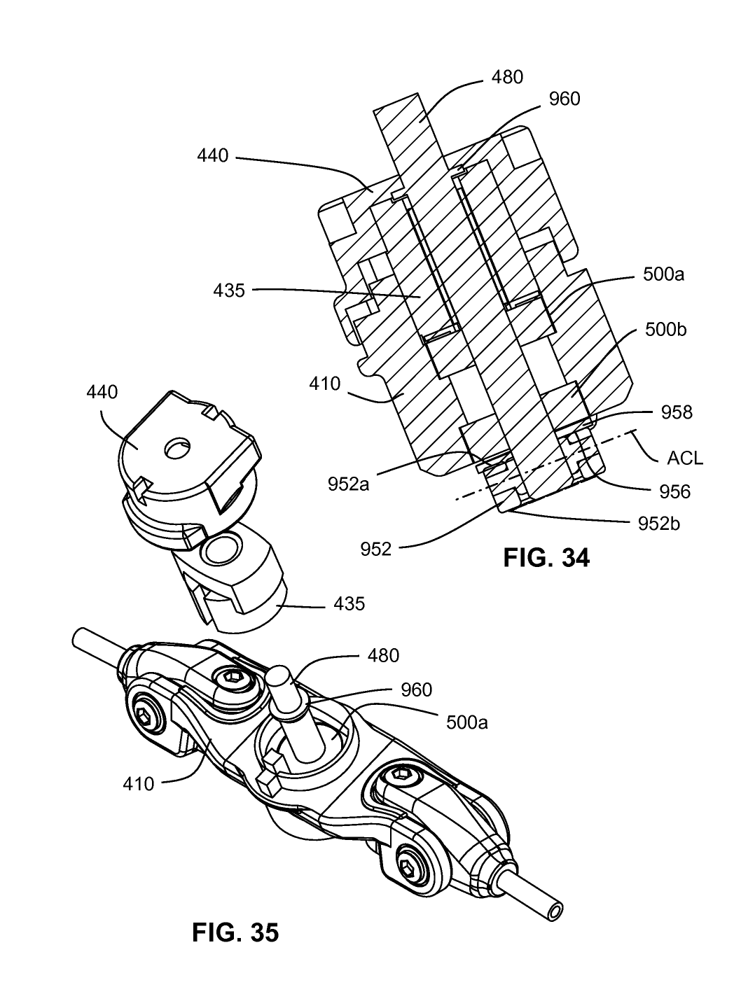

Other examples of drivers may be used in place of the driver 510. For example, reference is made to FIGS. 33A-33C which show a driver 950 that includes a cam lever 952 instead of a nut. The cam lever 952 is connected to the front pin 480 by any suitable means, such as by a threaded connection. The cam lever 952 is shown in FIG. 33A has a first side 952a and a second side 952b. When the cam lever 952 is swung over to the position shown in FIG. 33B, it may be said to be positioned in a first position in which the first side 952a abuts a cam abutment surface 956 which is a surface of a lock washer or other cam biasing member shown at 958. The lock washer (or more generally) the cam biasing member 958 (FIG. 34) itself abuts the bushing 500b. As a result, the cam lever 952 pulls the pin 480 so as to drive an engagement flange 960 on the pin 480 to compress the resilient member 435 against the first bushing 500a. Thus, in this first position the engagement of the first side 952a with the cam abutment surface 956 causes the cam lever 952 to compress the resilient member 435 with a first compression force (i.e. force FC1). As a result, the resilient member 435 applies a first resistive force RL1 at a given non-zero pivot angle for the front wheel support 410 and has a first effective spring rate. When the cam lever 952 is swung over to the position shown in FIG. 33C, it may be said to be positioned in a second position in which the second side 952b, which is farther from a pivot axis ACL of the cam lever than the first side 952a is, abuts the cam abutment surface 956. In this second position the engagement of the second side 952b with the cam abutment surface 956 causes the cam lever 952 to compress the resilient member 435 with a second compression force (i.e. force FC2) that is larger than the first compression force, thereby causing the resilient member 435 a second resistive force RL1 at the given non-zero pivot angle for the front wheel support 410 and has a second effective spring rate that is larger than the first effective spring rate.

It will be noted that the position shown in FIG. 33A is a release position in which the cam lever 952 does not cause any significant compression of the resilient member 435. It will be noted that this release position may itself constitute the first position and either of the positions shown in FIGS. 33B or 33C may constitute a second position in which the second effective spring rate of the resilient member 435 is made higher than in the first position shown in FIG. 33A.

It will be noted that the cam lever 952 may be on the underside of the front wheel support 410, as shown. Alternatively, the cam lever 952 and the pin 480 may be reversed so as to have an engagement flange 960 that engages the opposing face of the resilient member 435 (i.e. the lower face of the resilient member 435 in the view shown in FIG. 34) so that the cam lever 952 is on the upper face of the front cover 425. The cam biasing member 958 may be positioned between the cam lever and a surface that is substantially fixed in relation to the front wheel support 410 (such as a surface of the bushing 500b), as shown. Alternatively, the cam biasing member 958 may be positioned anywhere where it is flexed by the movement of the cam lever 952 to the first or second positions so as to assist in the compressive force acting on the resilient member 435.

that is movable between a first position, shown in FIG. 33B, wherein it generates a first amount of compression in the resilient member 435, and therefore a first resistance to twisting or pivoting of the front wheel support 410 about the axis K, and a second position, shown in FIG. 33B, wherein it generates a second amount of compression in the resilient member 435, and therefore a second resistance to twisting or pivoting of the front wheel support 410 about the axis K.

The resilient member 435 can take a variety of shapes and made from a variety of materials. For example, as shown in FIGS. 16A and 16B, the resilient member 435 can be a hexagonal bushing. As a hexagonal bushing, the resilient member 435 has planar sides 540 that are joined together at side edges 545. The side edges 545, at the portion 455, abut against corresponding side edges (not shown) in the recess 445 in the positioning member 440 and, at the portion 475, the side edges 545 abut against corresponding side edges (not shown) in the recess 465 in the front wheel support 410. The abutment of the sides 540 and side edges 545 against the corresponding sides and side edges of the front wheel support 410 and the positioning member 440 helps prevent the resilient member 435 from pivoting in respect of the front wheel support 410 at the portion 475 and in respect of the foot-deck 105 at the portion 455.

In some embodiments, the resilient member 435 is made from a polyurethane material. However, any suitable material or combination of materials for the resilient member 435 is contemplated.

As stated above, the resilient member 435 can be partially sleeved on the front pin 480 via the aperture 485. In some embodiments, the aperture 485 may not be closed about the front pin 480 such that the resilient member 435 does not completely surround the front pin 480. For example, the resilient member 435 may be C-shaped.

The braking mechanism 200 may include features to align the primary brake member 205 with the secondary brake member 210 when the primary brake member 205 is in the braking position. For example, the primary brake member 205 may include a first alignment surface and the braking wheel 135 may be associated with a second alignment surface that is engaged by the first alignment surface during movement of the primary brake member 205 towards the braking position so as to align the braking wheel 135 in a selected direction relative to a longitudinal axis D of the foot-deck 105.

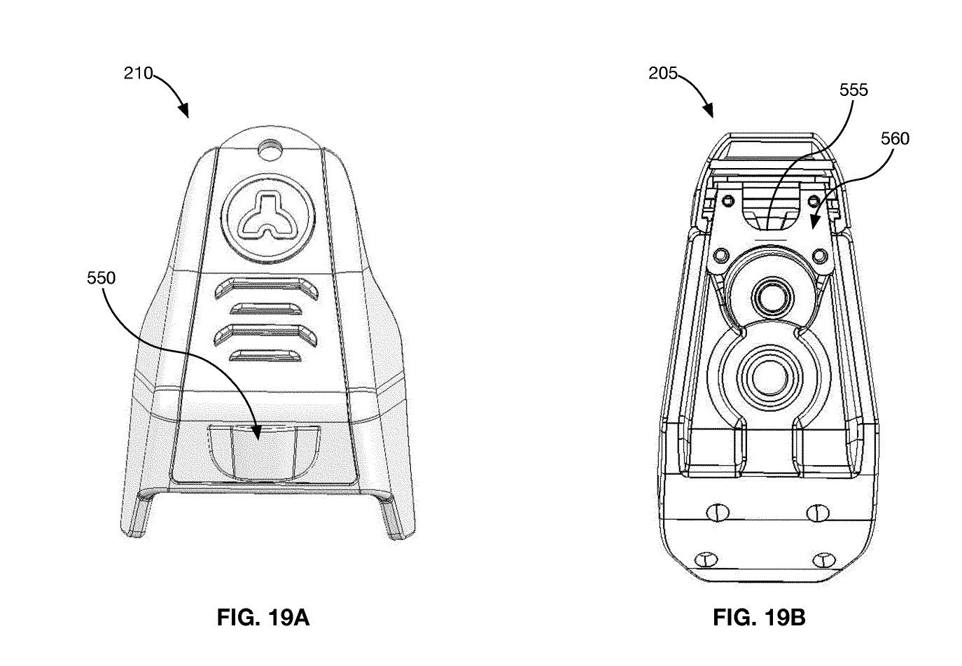

In the example braking mechanism 200, the primary brake member 205 includes an engagement bracket 560 having a first alignment surface 555 (FIG. 19B), depicted as an interior surface of a cut out in the engagement bracket 560, and the secondary brake member 210 includes a second alignment surface 550 in the form of a boss on the exterior braking surface 265 that is configured to engage the first alignment surface 555 (FIG. 19A). While the primary brake member 205 is being depressed towards the secondary brake member 205, the first alignment surface 555 (as a cut out in the engagement bracket 560 in the example braking mechanism 200) engages the secondary alignment surface 550 (as a boss in the example braking mechanism 200) to move the secondary alignment surface 550 to a selected position that is, for example, aligned with the longitudinal axis D of the foot-deck 105. For example, in the braking position, the second alignment surface 550 is seated in the first alignment surface 555 and the secondary brake member 210 is aligned with the primary brake member 205.

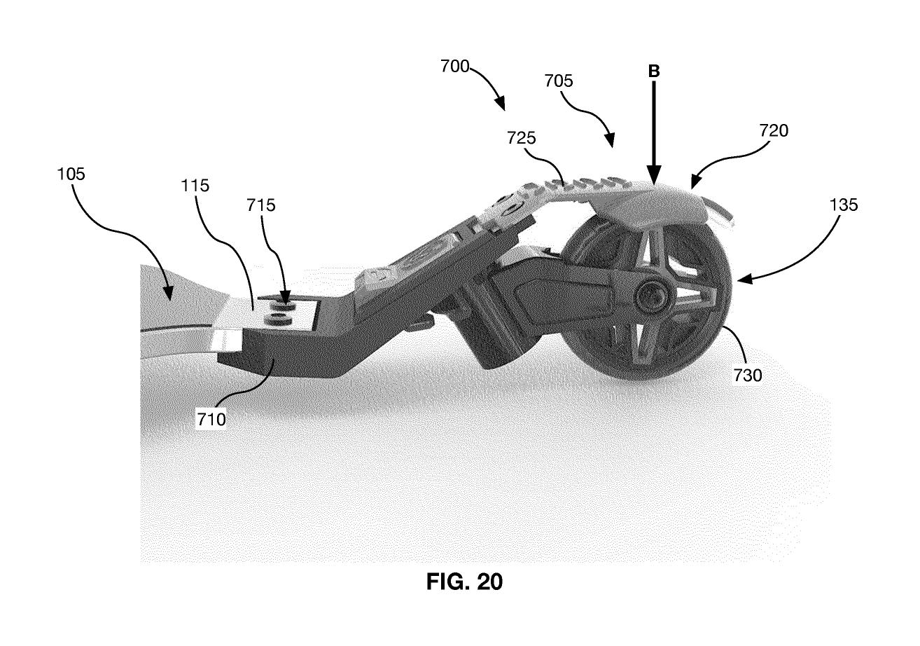

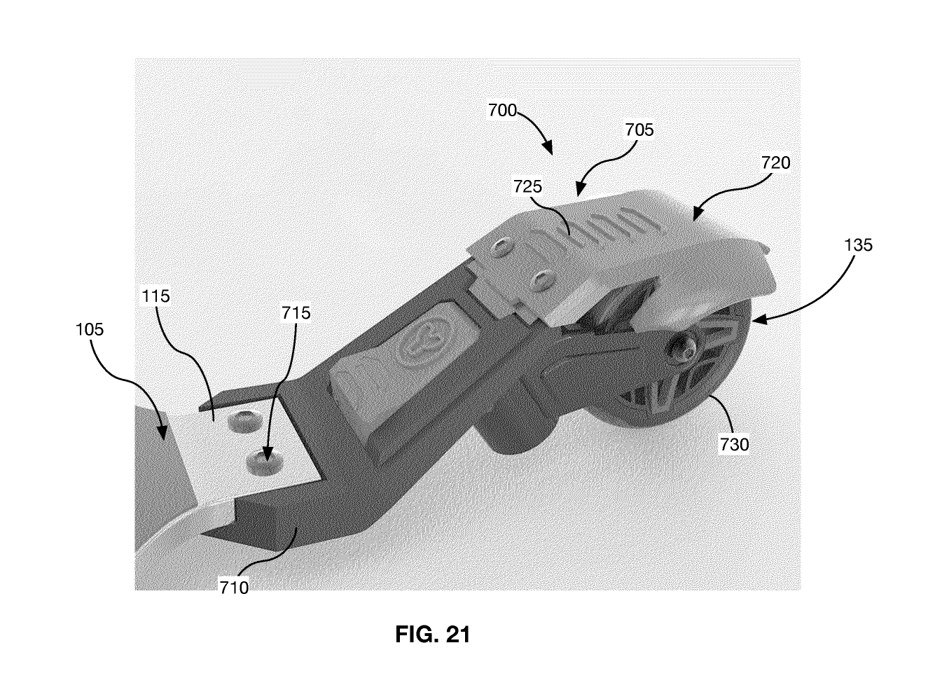

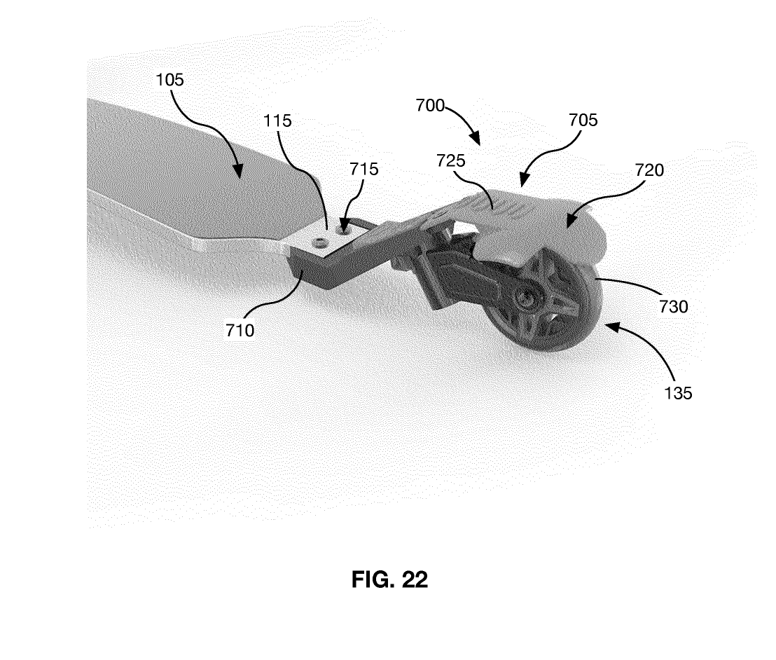

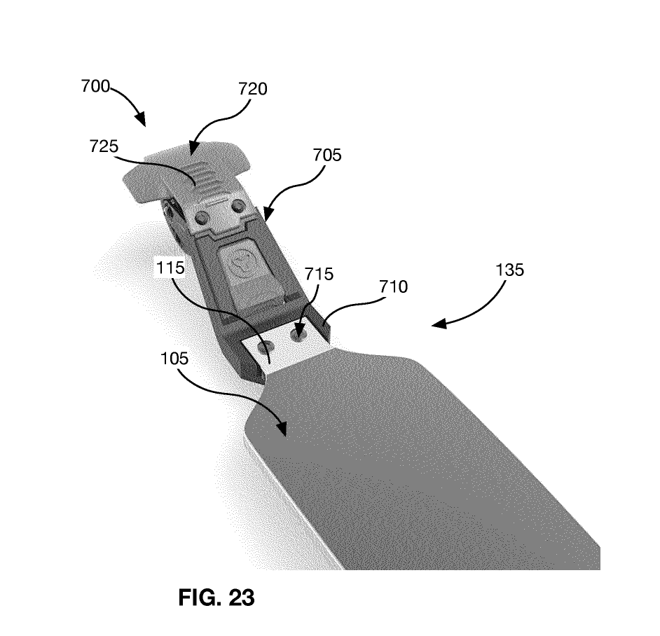

FIGS. 20 to 23, depict another example braking mechanism 700 that includes a single brake, brake 705. Similarly to the braking mechanism 200, the braking mechanism 700 can be used with the foot-deck-based vehicle 100 and the braking wheel 135.

The brake member 705 is coupled to the rear end 115 of the foot-deck 105. For example, a first end 710 of the brake member 705 can be coupled to the rear end 115 using fasteners 715. The brake member 705 includes an engagement portion 720 that is depressible towards the braking wheel 135. When a transfer force B is applied to the brake member 705 (at, for example, a loading region 725 of the engagement portion 720), the engagement portion 720 flattens as the engagement portion 720 moves towards the braking wheel 135. The engagement portion 720 is depressible towards the braking wheel 135 to a braking position (not shown) where the engagement portion 720 frictionally engages an exterior surface 730 of the braking wheel 135 to reduce the speed of the foot-deck based vehicle 100. The engagement portion 720 is configured to move to a non-braking position (FIGS. 20 to 23) away from the braking wheel 135 when the transfer force B is removed. For example, the engagement portion 720 may include a resilient member, such as a leaf spring, that is biased to move the engagement portion 720 to the non-braking position. In some embodiments, the brake member 705 is resiliently movable between the braking and the no-braking positions by way of a living hinge.

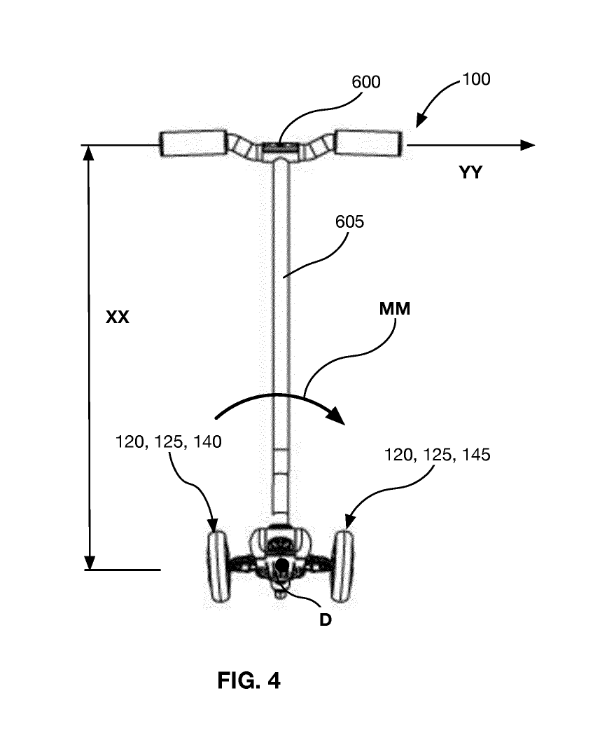

The foot-deck-based vehicle 100 can include features to enhance usability and safety. For example, the foot-deck-based vehicle 100, as part of the braking mechanism 200, may include a handlebar support member 605 (FIG. 1) that extends upwards from the foot-deck 105, when the foot-deck-based vehicle 100 is in use, and a handlebar 600 on the handlebar support member 605. The handlebar 600 may be at a distance XX from the longitudinal axis of the foot-deck 105. The handlebar 600 may be movable laterally (e.g., from side-to-side, in the direction of YY) to exert a moment MM (FIG. 4) on the foot-deck 105 about the longitudinal axis of the foot-deck 105, to cause a pivoting of the foot-deck 105 and the rear pin 155 about the longitudinal axis D of the foot-deck 105. The pivoting of the foot-deck 105 and the rear pin 155 about the longitudinal axis D of the foot-deck 105 causes the rear wheel support 160 and the braking wheel 135 to pivot about the rear pin 155 to steer the foot-deck-based-vehicle 100. Similar features may be included in an example foot-deck-based vehicle 800 that is described below.

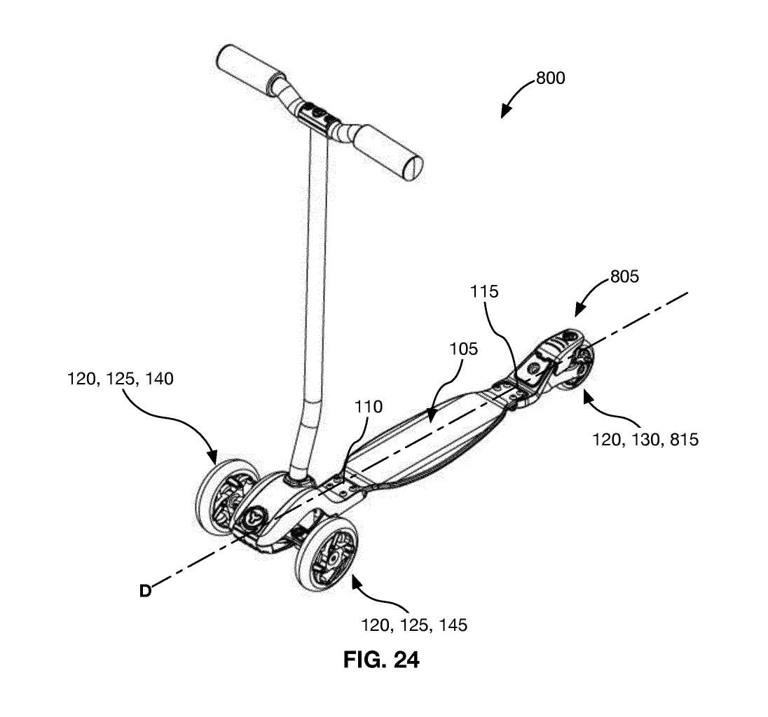

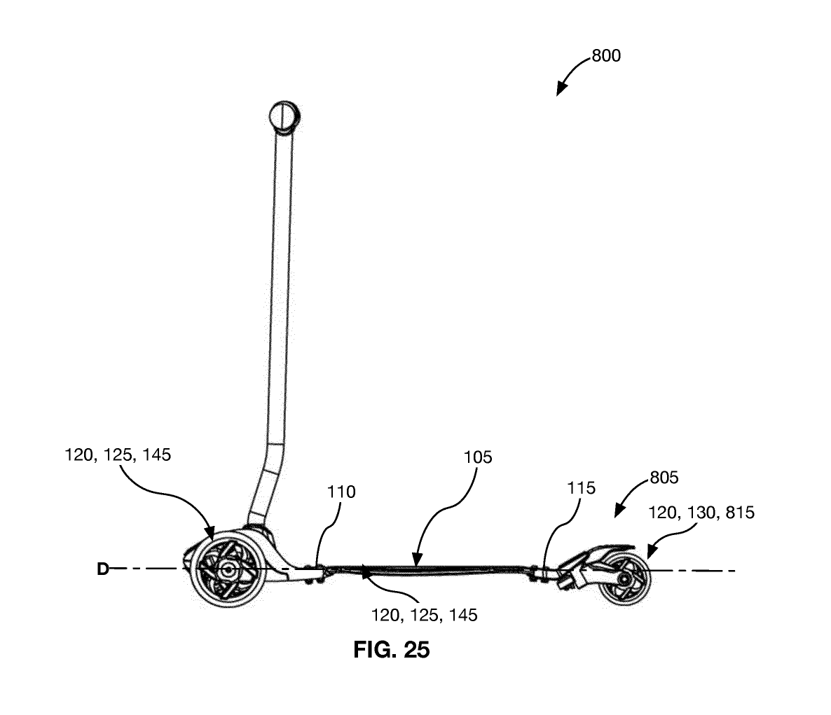

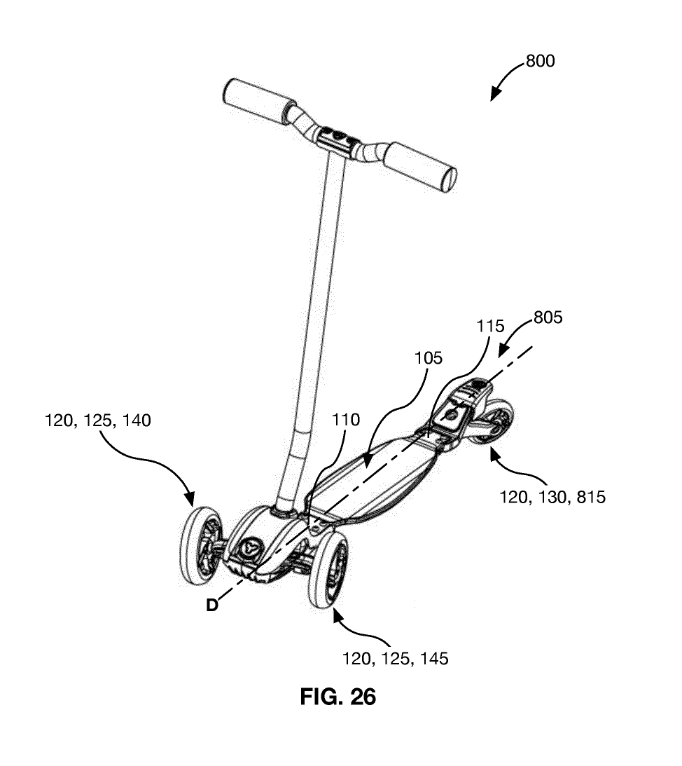

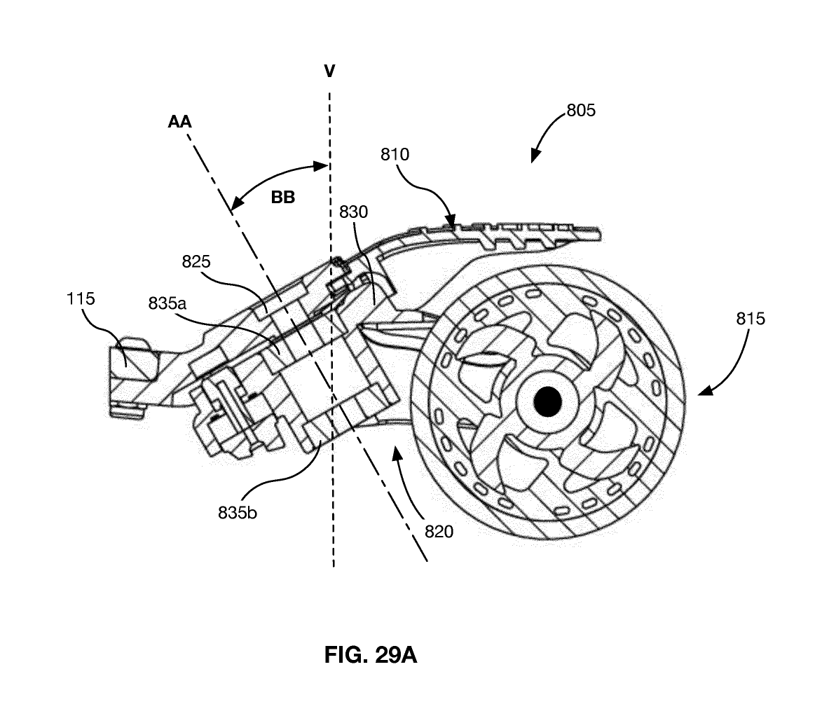

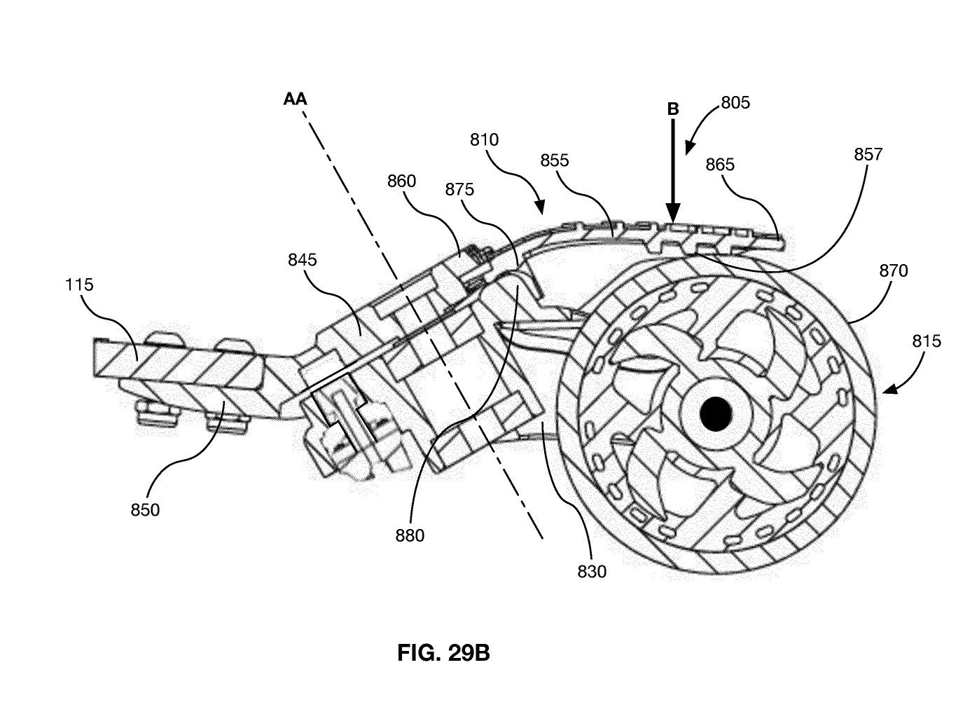

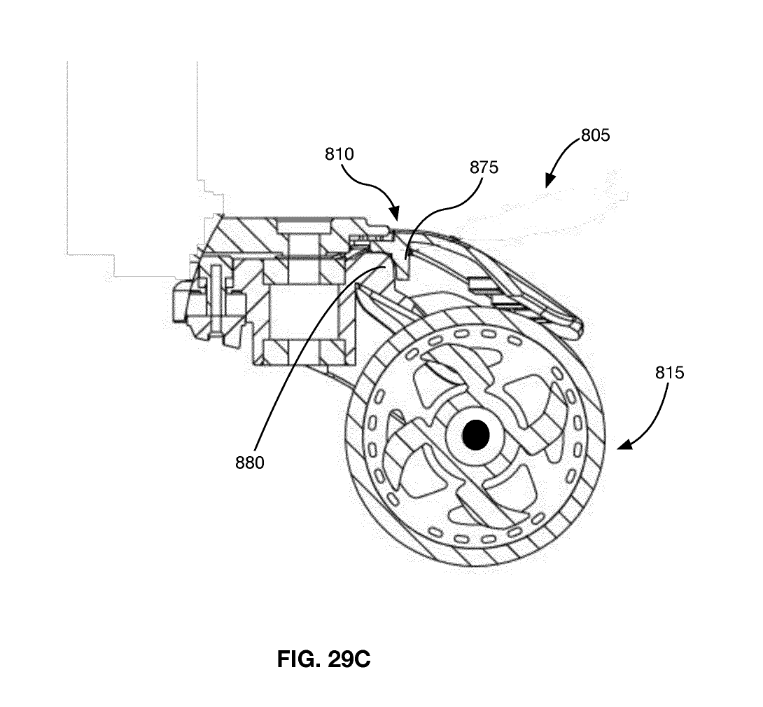

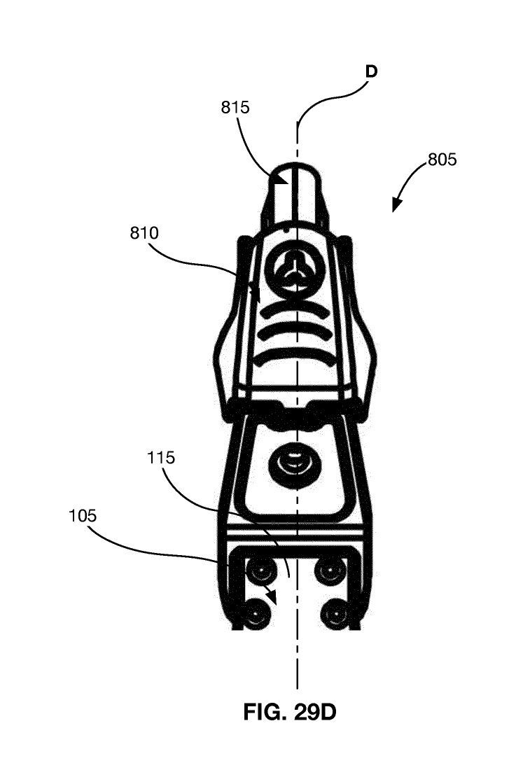

FIGS. 24 to 29C depict the example foot-deck-based vehicle 800. The foot-deck-based vehicle 800 includes many components similar to those of the foot-deck-based vehicle 100, with like or similar components given like or similar numbers. Similarly to the foot-deck-based vehicle 100, the foot-deck based vehicle 800 includes a plurality of wheels 120 that includes at least one front wheel 125 proximate the front end 110 of the foot-deck, and at least one rear wheel 130 proximate the rear end 115 of the foot-deck. At least one of the at least one rear wheel 130 is a braking wheel 815. Similarly to the braking wheel 135, the braking wheel 815 is pivotally connected to foot-deck 105 for swivel movement about a rear swivel axis. For example, as shown in FIG. 29A, the braking wheel 815 is included in a braking wheel assembly 820 that includes a rear pin 825 and a rear wheel support 830. The rear pin 825 has a rear pin longitudinal axis AA that, in the example braking wheel 815, defines the swivel axis of the braking wheel 815 and is at an acute angle BB (i.e., greater than zero degrees and less than ninety degrees) relative to the vertical axis V when the foot-deck-based-vehicle is upright or in use. The rear wheel support 830 is pivotally coupled to the rear pin 825 via, for example, bushings 835a and 835b. However, any suitable manner of pivotally coupling the rear wheel support 830 to the rear pin 825 is contemplated. For example, in some embodiments, the bushings 835a and 835b are substituted by ball bearings or roller bearings. Furthermore, any suitable manner of pivotally connecting the braking wheel 815 to the foot-deck 105 is contemplated.

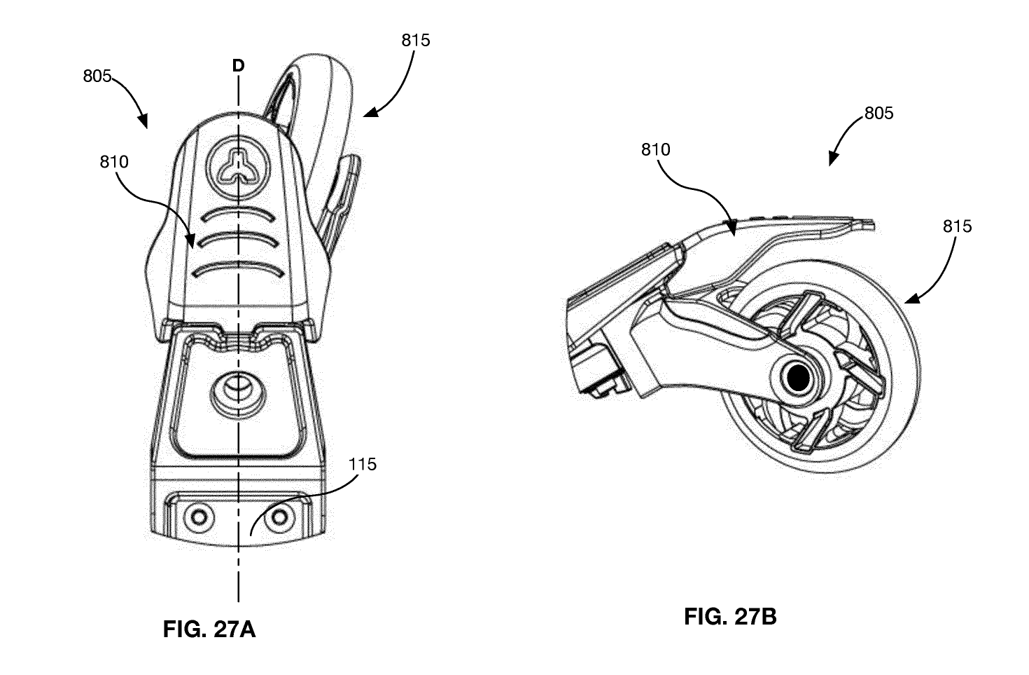

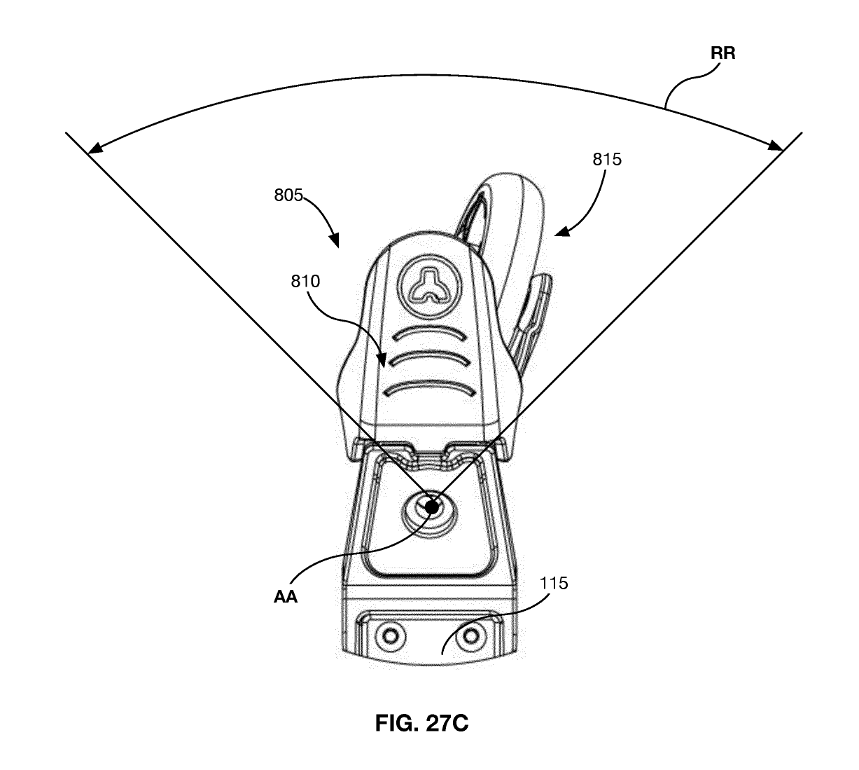

The braking wheel 815 is rotatably coupled on the rear wheel support 830. For example, the braking wheel 815 is rotatably coupled to the rear wheel support 830 by a rear axle 840. The rear wheel support 830 is pivotally coupled to the rear pin 825. The rear wheel support 830, along with the braking wheel 815, can pivot together about the longitudinal axis AA of the pin 825. Again, the braking wheel 815 is connected for swivel movement about the rear swivel axis (the rear pin longitudinal axis AA for the example braking wheel 815), through a range of angular positions RR, as shown in FIG. 27C.

In contrast to the foot-deck-based vehicle 100, the foot-deck-based vehicle 800 includes an example braking mechanism 805. The example braking mechanism 805 includes a brake member 810 coupled to the rear end 115 of the foot-deck 105. The brake member 810 is configured to move between a braking position (FIG. 29B) and a non-braking position (FIG. 29A). In the braking position, the brake member 810 is depressed towards the braking wheel 815 and drives a brake surface to a frictionally engaging position at which the brake surface frictionally engages the braking wheel 815 to reduce a speed of the foot-deck-based vehicle 800 regardless of the angular position of the braking wheel 815 within the range of angular positions RR, and a non-braking position. In the non-braking position, the brake member 810 permits movement of the brake surface away from the braking wheel 815. In some embodiments, the brake surface is on the brake member 810.

In use, the brake member 810 is moved to the brake position by a transfer force B (FIG. 29B), depressing the brake member 810 towards the braking wheel 815. In the example braking mechanism 805, the brake surface is on the brake member 810, particularly brake surface 857, and the application of the transfer force B to the brake member 810 drives the brake surface 857 to a frictionally engaging position at which the brake surface 857 frictionally engages the braking wheel 815 to reduce a speed of the foot-deck-based vehicle 800 regardless of the angular position of the braking wheel 815 within the range of angular positions RR.

In the non-braking position (FIG. 29A), the brake member 810 permits movement of the brake surface 857 away from the braking wheel 815. For example, as stated above, the brake member 810 can be biased to the non-braking position. As a result, when the brake member 810 is not being depressed towards the braking wheel 815, the brake member 810 can move to the non-braking position. In some embodiments, the brake member 810 coupled to the rear end 115 of the foot-deck 105 in a cantilevered manner and is resiliently movable between the braking and non-braking positions by way of a living hinge.

In some embodiments, the brake member 810 includes an extension portion 845, which includes a first end 850 of the brake member 810 (coupled to the rear end 115 of the foot-deck 105), and an engagement portion 855, which is coupled to a second end 860 of the extension portion 845, and includes a free end 865. The engagement portion 855 includes the braking surface 857 and is configured to frictionally engage an exterior braking surface 870 of the braking wheel 815 when the brake member 810 is in the braking position. The engagement portion 855 may be formed from any suitable material or combination of suitable materials, such as a suitable rubber or plastic.

The brake member 810 may be biased to the non-braking position. For example, the brake member 810 can be made from a resilient material that returns to the non-braking position when the user is no longer applying the transfer force B to the brake member 810. As another example, the brake member 810 may include a spring (not shown), such as a leaf spring, that is biased to urge the brake member 810 towards the non-braking position.

The braking mechanism 800 may include features to align the braking wheel 815 in a selected direction. For example, the brake member 810 may include a first alignment surface and the rear wheel support 830 has thereon a second alignment surface that is engaged by the first alignment surface during movement of the brake member 810 towards the braking position so as to align the braking wheel 815 in a selected direction relative to the longitudinal axis D of the foot-deck 105.

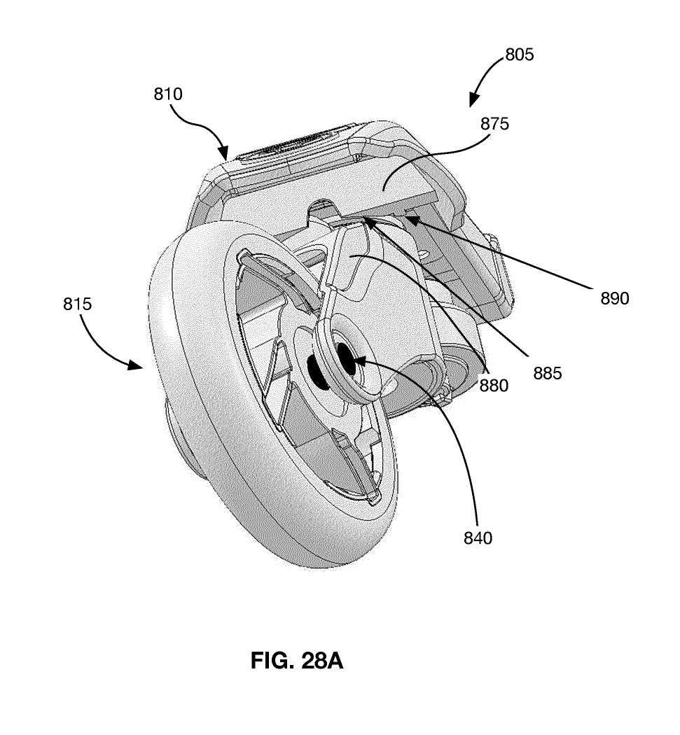

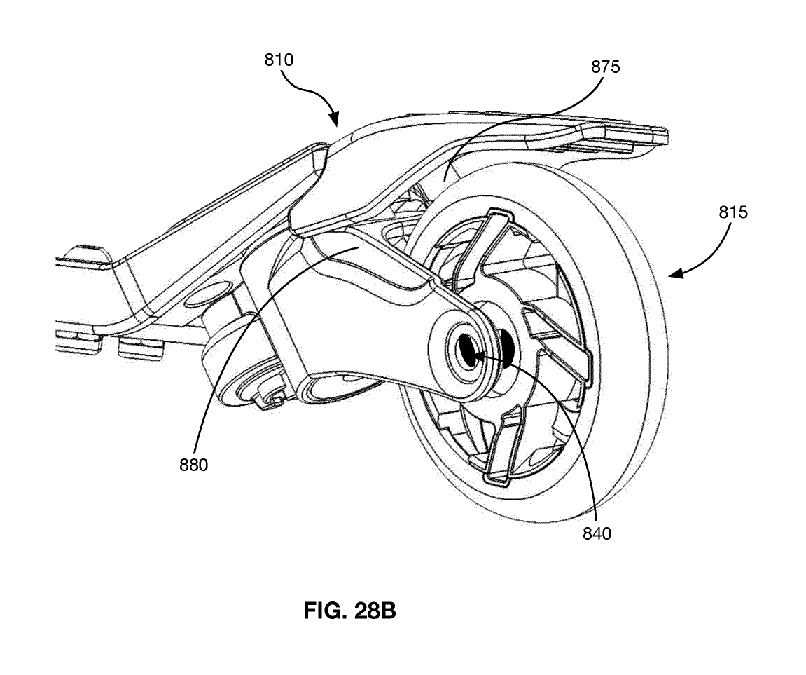

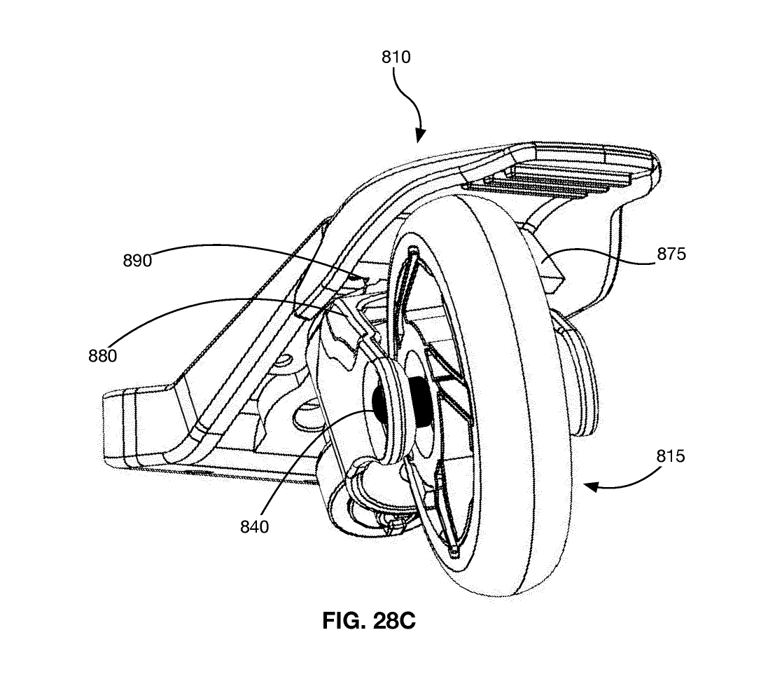

The braking mechanism 805 is configured to pivot the braking wheel 815 about the swivel axis AA such that the braking wheel 815 is aligned with the brake 810 when the brake 810 is in the braking position. For example, the brake member 810 can include an alignment member 875 that is configured to engage alignment shoulders 880 on the wheel support 830 (FIGS. 28A, 28B and 29B). The alignment member 875 can have angled first alignment surfaces 885 that contact a second alignment surface in the form of, for example, alignment shoulders 880 on the rear wheel support 830 to compel the braking wheel 815 to pivot about the swivel axis AA to reach a position in which the braking wheel 815 is aligned with the longitudinal axis D of the foot-deck 105 (FIG. 29D). In the example braking mechanism 805, the brake member 810 is coupled to the rear end 115 of the foot-deck 105 such that the brake member 810 is aligned with the longitudinal axis D of the foot-deck 105 (FIG. 27A). When the brake member 810 is depressed towards the braking wheel 815, the angled first alignment surfaces 885 contact the alignment shoulders 880. The alignment shoulders 880 ride against the angled first alignment surfaces 885 such that the rear wheel support 830 is pivoted, with the braking wheel 815, about the swivel axis AA to a position in which the braking wheel 815 is aligned with the longitudinal axis D of the foot-deck 105 (FIG. 29D). To help maintain the aligned position of the braking wheel 815 with the brake member 810 while the brake member 810 is in the braking position, the alignment member 875 can include abutment bosses 890 (FIGS. 28A, 28C). The abutment bosses 890 are configured to retain the alignment shoulders 880 of the rear wheel support 830 between them. For example, the alignment bosses 890 are at a distance from each other such that the rear wheel support 830 is nested between them when the brake member 810 is in the braking position.

In the example embodiment, the alignment member 875 is positioned to engage the alignment shoulders 880 prior to the frictional engagement of the brake member 810 with the braking wheel 815. As a result, the braking wheel 810 is aligned with the brake member 810 prior to the brake member 810 being in the braking position (FIG. 29C). However, in some embodiments, the alignment shoulders 880 are positioned such that the braking wheel 815 is aligned contemporaneously with the brake member 810 being in the braking position.

In some embodiments, the braking wheel 815 has associated therewith the second alignment surface that is engaged by the first alignment surface during movement of the brake member 810 towards the braking position so as to align the braking wheel 815 in a selected direction relative to the longitudinal axis D of the foot-deck 105. For example, in some embodiments, the second alignment surface is the exterior surface 870 of the braking wheel 815. The alignment member 875, having the angled first alignment surfaces 885, may be configured such that the angled first alignment surfaces 885 engage the exterior surface 870 of the braking wheel 875 instead of the alignment shoulders 880. The exterior surface 870 of the braking wheel 815 would ride against the angled first alignment surfaces 885 as the brake member 810 is depressed towards the braking wheel 815 such that the rear wheel support 830 is pivoted, with the braking wheel 815, about the swivel axis AA to a position in which the braking wheel 815 is aligned with the longitudinal axis D of the foot-deck 105.

It is understood that the selected direction that the braking wheel 815 is aligned relative to is not limited to along the longitudinal axis D of the foot-deck 105, but may be angularly offset from the longitudinal axis D of the foot-deck 105 in some embodiments.

As in the braking mechanism 200, in some situations, the user may want a more traditional ride of the foot-deck-based vehicle 800 and to restrain the braking wheel 815 from swivelling movement.

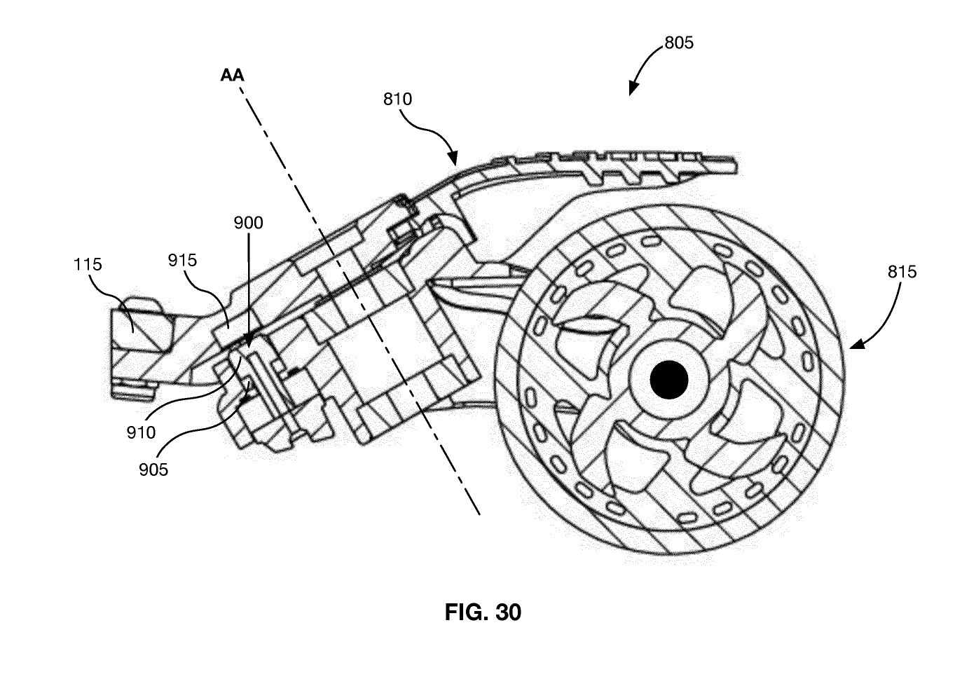

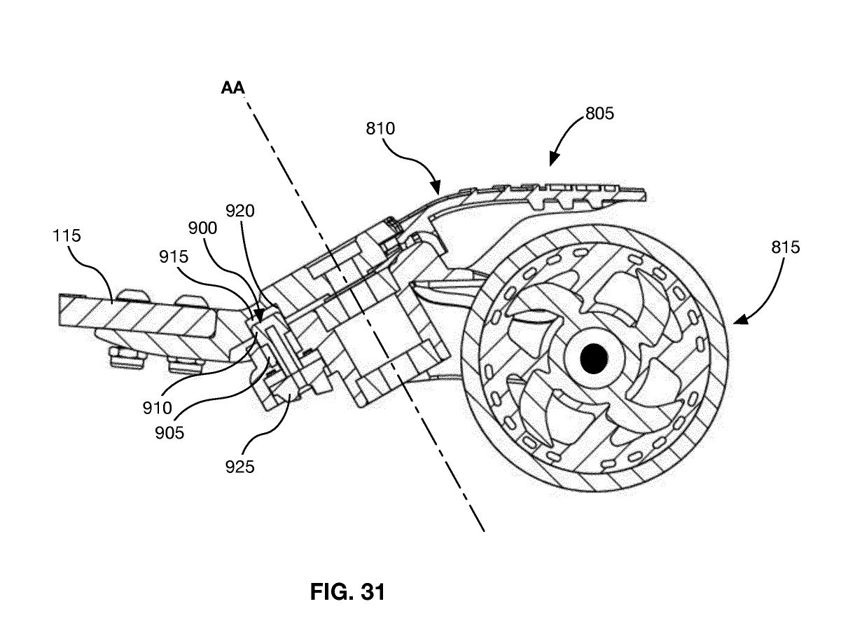

As better shown in FIGS. 30 to 32, the braking mechanism 805 can include an example locking member 900 that is coupled to the rear wheel support 830. In use, the locking member 900 is retained in a retaining aperture 905 in the rear wheel support 830 and can include an engagement member 910. The locking member 900 is configured to move between a non-locking position out of engagement with the brake member 810 (FIG. 30) and a locking position in which the locking member 900 engages with the brake member 810 to restrict swivel movement of the braking wheel 815 (FIG. 31). The wheel support 830 can include an engagement aperture 915 that is configured to fittingly receive the locking member 900 (e.g., via the engagement member 910) when the locking member 900 is in the locking position. For example, the engagement aperture 915 can be sized and shaped to correspond with the size and shape of the engagement member 910.

In use, the when the locking member 900 is in the non-locking position the engagement member 910 is not retained by the engagement aperture 915 on the brake member 810, and the rear wheel support 830, along with the braking wheel 815, is able to swivel about the swivel axis AA. However, when the locking member 900 is in the locking position, the locking member 900 is moved such that the engagement member 910 is fittingly received by the engagement aperture 915. As shown in FIG. 31, while in the locking position, the engagement member 910 frictionally engages an interior surface 920 of the engagement aperture 915 to help retain the locking member 900 in the engagement aperture 915. The braking wheel 815 is then restricted to moving with the foot-deck 105 and the brake member 810, and prevented from swivelling about the swivel axis AA.

The locking member 900 can include a graspable portion 925 that can be used to depress the locking member 900 towards the engagement aperture 915 to place the locking member 900 in the locking position. The graspable portion 925 may also be used pull the locking member 900 out of the locking position and position the locking member in the non-locking position.

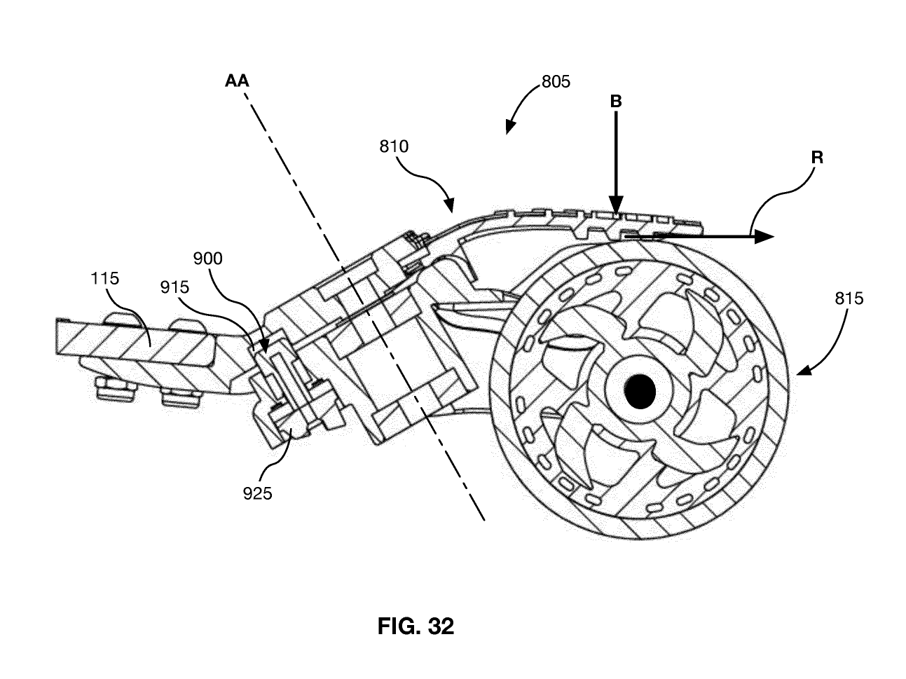

The braking mechanism 805 can still be used to reduce the speed of the foot-deck-based vehicle 800 even when the braking wheel 815 is restricted from swivel movement by the locking member 900. As shown in FIGS. 31 and 32, the brake member 810 remains moveable between the non-braking (FIG. 31) and braking positions (FIG. 32) while the locking member 900 is in the locked position.

Persons skilled in the art will appreciate that there are yet more alternative implementations and modifications possible, and that the above examples are only illustrations of one or more implementations. The scope, therefore, is only to be limited by the claims appended hereto.

1-25. (canceled)

26. A centering mechanism for a front wheel assembly of a foot-deck-based vehicle, the front wheel assembly having a front wheel support configured to pivot about a front wheel support pivot axis at an acute angle to a vertical axis when the foot-deck-based vehicle is upright, and a first front wheel and a second front wheel, the centering mechanism comprising:
a resilient member coupled to the front wheel support and to the foot-deck; and
an adjustable bearing member configured to be movable between a first position in which the adjustable bearing member applies a first compressive force to the resilient member thereby providing the resilient member with a first effective spring rate for resisting pivoting of the front wheel support about the front wheel support pivot axis, and a second position in which the adjustable bearing member applies a second compressive force to the resilient member thereby providing the resilient member with a second effective spring rate for resisting pivoting of the front wheel support about the front wheel support pivot axis;
wherein the second effective spring rate is greater than the first effective spring rate.

27. A centering mechanism as claimed in claim 26, wherein the first compressive force is approximately zero.

28. A centering mechanism as claimed in claim 26, further comprising a front pin aligned with the front wheel support pivot axis, wherein:
the front pin is coupled to the front wheel support and the foot-deck, and
wherein the resilient member includes a resilient member aperture therethrough and the resilient member is at least partially sleeved on the front pin via the resilient member aperture.

29. A centering mechanism as claimed in claim 26, wherein the adjustable bearing member is coupled to the front pin and is configured to move along the front pin between the first position and the second position.

30. A centering mechanism as claimed in claim 26, further comprising:
a driver coupled to the pin and configured to move the adjustable bearing member between the first position and the second position.

31. A centering mechanism as claimed in claim 26, wherein the adjustable bearing member includes at least one bushing.

32. A centering mechanism as claimed in claim 26, wherein the resilient member is a hexagonal bushing.

33. A centering mechanism as claimed in claim 32, wherein the resilient member comprises a polyurethane material.

34. A foot-deck-based vehicle, comprising:
a foot deck defining a foot support plane;
a front wheel support configured to support the foot deck and to pivot about a front wheel support pivot axis having an acute angle to the foot support plane;
a first front wheel and a second front wheel rotatably mounted to the front wheel support; and
a centering mechanism including
a resilient member coupled to the front wheel support and to the foot-deck, and
an adjustable bearing member configured to be movable between a first position in which the adjustable bearing member applies a first compressive force to the resilient member such that the resilient member generates a first effective spring rate for the resilient member in relation to pivoting of the front wheel support about the front wheel support pivot axis, and a second position in which the adjustable bearing member applies a second compressive force to the resilient member such that the resilient member generates a second effective spring rate for the resilient member in relation to pivoting of the front wheel support about the front wheel support pivot axis;
wherein the second effective spring rate is greater than the first effective spring rate.

35. A foot-deck-based vehicle as claimed in claim 34, wherein the first compressive force is approximately zero.

36. A foot-deck-based vehicle as claimed in claim 34, further comprising a front pin aligned with the front wheel support pivot axis, wherein:
the front pin is coupled to the front wheel support and the foot-deck, and
wherein the resilient member includes a resilient member aperture therethrough and the resilient member is at least partially sleeved on the front pin via the resilient member aperture.

37. A foot-deck-based vehicle as claimed in claim 34, wherein the adjustable bearing member is coupled to the front pin and is configured to move along the front pin between the first position and the second position.

38. A foot-deck-based vehicle as claimed in claim 34, further comprising:
a driver coupled to the pin and configured to move the adjustable bearing member between the first position and the second position.

39. A foot-deck-based vehicle as claimed in claim 34, wherein the adjustable bearing member includes at least one bushing.

40. A foot-deck-based vehicle as claimed in claim 34, wherein the resilient member is a hexagonal bushing.

41. A foot-deck-based vehicle as claimed in claim 40, wherein the resilient member comprises a polyurethane material.

42-43. (canceled)

44. A foot-deck-based vehicle, comprising:
a foot deck defining a foot support plane;
a front wheel support configured to support the foot deck and to pivot about a front wheel support pivot axis having an acute angle to the foot support plane;
a first front wheel and a second front wheel rotatably mounted to the front wheel support; and
a centering mechanism including
a resilient member coupled to the front wheel support and to the foot-deck, and
a cam lever movable between a first position in which the cam lever causes a first compressive force to be applied to the resilient member causing the resilient member to have a first effective spring rate in relation to resisting pivoting of the front wheel support about the front wheel support pivot axis, and a second position in which the cam lever causes a second compressive force to be applied to the resilient member causing the resilient member to have a second effective spring rate in relation to resisting pivoting of the front wheel support about the front wheel support pivot axis, wherein the second effective spring rate is greater than the first effective spring rate.
